(19) United States
(12) Patent Application Publication
(10) Pub. No.: US 2025/0080711 A1
(43) Pub. Date: Mar. 6, 2025

(54) IMAGE PROCESSING APPARATUS AND IMAGE PROCESSING METHOD

(71) Applicant: Sony Group Corporation, Tokyo (JP)

(72) Inventors: Hiroyuki YASUDA, Saitama (JP); Satoru KUMA, Tokyo (JP); Koji YANO, Tokyo (JP); Ohji NAKAGAMI, Tokyo (JP)

(73) Assignee: Sony Group Corporation, Tokyo (JP)

(21) Appl. No.: 18/285,586

(22) PCT Filed: Jan. 27, 2022
(86) PCT No.: PCT/JP2022/003003

§ 371 Date: Oct. 4, 2023

(30) Foreign Application Priority Data
Apr. 26, 2021 (JP) 2021-073841

(51) Int. Cl. H04N 13/161; G06T 7/521; G06T 9/00; H04N 13/178

(52) U.S. Cl. CPC H04N 13/161; G06T 7/521; G06T 9/00; H04N 13/178

(57) ABSTRACT

The present disclosure relates to an image processing apparatus and image processing method capable of scalably decoding coded data of 3D data having a three-dimensional structure and detected in a real space.

3D data having a three-dimensional structure and detected in a real space is sorted into main signal data and background signal data on the basis of signal intensity, and each of the sorted main signal data and the background signal data is encoded to generate coded data. The present disclosure can be applied to, for example, an image processing apparatus, an electronic device, an image processing method, a program, and the like.

### TECHNICAL FIELD

The present disclosure relates to an image processing apparatus and an image processing method, and more particularly, to an image processing apparatus and image processing method capable of scalably decoding coded data of 3D data having a three-dimensional structure and detected in a real space.

### BACKGROUND ART

Conventionally, there has been a light detection and ranging (LiDAR), which is sensing technology for irradiating a real space with laser light and detecting a distance to an object, a property of the object, and the like with a direct time of flight (dToF) method, for example. With such sensing technology, for example, 3D data having a three-dimensional structure such as data of reflection intensity for each three-dimensional position (that is, a reflection intensity distribution in a 3D space) is obtained as sensor data. Such 3D data generally has a large amount of information, and thus is required to be compressed (encoded).

In particular, sensor data obtained by the LiDAR of the dToF method generally includes many noise components, non-zero information is distributed in an entire space, and an amount of encoding increases, by which a load of decoding processing also increases. Therefore, scalable decoding according to application is required.

As a method for compressing 3D data, for example, there is a method for reducing an amount of information by utilizing a silhouette image of an object as an occupancy (refer to Non-Patent Document 1, for example). Furthermore, there is a method for converting 3D data to 2D data having a two-dimensional structure by dividing the 3D data by a plane to achieve a high compression rate by applying a 2D encoding method (refer to Non-Patent Document 2, for example).

### CITATION LIST

### Non-Patent Document

Non-Patent Document 1: “ICIP 2020”, https://ieeexplore.ieee.org/abstract/document/9190648

### Patent Document

Patent Document 1: US Patent Application Publication No. 2019/0051017A1 Specification

### SUMMARY OF THE INVENTION

### Problems to be Solved by the Invention

However, it is difficult to perform scalable decoding with these methods.

The present disclosure has been made in view of such a situation, and an object thereof is to enable scalable decoding of coded data of 3D data having a three-dimensional structure and detected in a real space.

### Solutions to Problems

An image processing apparatus according to one aspect of the present technology is an image processing apparatus including a sorting unit that sorts, on the basis of a signal intensity, a 3D data having a three-dimensional structure and detected in a real space, into a main signal data and a background signal data, and an encoding unit that encodes each of the main signal data and the background signal data that are sorted out by the sorting unit, to generate coded data.

An image processing method according to one aspect of the present technology is an image processing method including sorting 3D data having a three-dimensional structure and detected in a real space into main signal data and background signal data on the basis of signal intensity, and encoding each of the sorted main signal data and the background signal data to generate coded data.

An image processing apparatus according to another aspect of the present technology is an image processing apparatus including a decoding unit that decodes coded data of each of main signal data and background signal data that are obtained by sorting, on the basis of signal intensity, 3D data having a three-dimensional structure and detected in a real space, to generate the main signal data and the background signal data, and a combining unit that combines the main signal data and the background signal data that are generated by the decoding unit, to generate the 3D data.

An image processing method according to another aspect of the present technology is an image processing method including decoding coded data of each of main signal data and background signal data that are obtained by sorting, on the basis of signal intensity, 3D data having a three-dimensional structure and detected in a real space, to generate the main signal data and the background signal data, and combining the generated main signal data and background signal data, to generate the 3D data.

In the image processing apparatus and method according to one aspect of the present technology, 3D data having a three-dimensional structure and detected in a real space is sorted into main signal data and background signal data on the basis of signal intensity, and each of the sorted main signal data and background signal data is encoded to generate coded data.

In an image processing apparatus and method according to another aspect of the present technology, coded data of each of main signal data and background signal data that are obtained by sorting, on the basis of signal intensity, 3D data having a three-dimensional structure and detected in a real space is decoded to generate the main signal data and the background signal data, and the generated main signal data and background signal data are combined to generate the 3D data.

### BRIEF DESCRIPTION OF DRAWINGS

FIG. 1 is a diagram describing sensor data of LiDAR.

FIG. 2 is a diagram describing an example of a method for converting 3D data to 2D data.

FIG. 3 is a diagram describing an example of a method for converting 3D data to 2D data.

FIG. 4 is a diagram illustrating an example of sensor data.

FIG. 5 is a diagram illustrating an example of sensor data.

FIG. 6 is a diagram describing encoding/decoding of 3D data detected in a real space.

FIG. 7 is a diagram describing an example of a state of sorting.

FIG. 8 is a diagram describing an example of a state of sorting.

FIG. 9 is a diagram illustrating an example of main signal data.

FIG. 10 is a diagram illustrating an example of background signal data.

FIG. 11 is a block diagram illustrating a main configuration example of an encoding apparatus.

FIG. 12 is a flowchart describing an example of a flow of encoding processing.

FIG. 13 is a flowchart describing an example of a flow of sorting processing.

FIG. 14 is a block diagram illustrating a main configuration example of a decoding apparatus.

FIG. 15 is a flowchart describing an example of a flow of decoding processing.

FIG. 16 is a diagram describing an example of a state of sorting.

FIG. 17 is a block diagram illustrating a main configuration example of an encoding apparatus.

FIG. 18 is a flowchart describing an example of a flow of encoding processing.

FIG. 19 is a block diagram illustrating a main configuration example of a decoding apparatus.

FIG. 20 is a flowchart describing an example of a flow of decoding processing.

FIG. 21 is a diagram describing an example of a state of sorting.

FIG. 22 is a block diagram illustrating a main configuration example of an encoding apparatus.

FIG. 23 is a flowchart describing an example of a flow of encoding processing.

FIG. 24 is a block diagram illustrating a main configuration example of a decoding apparatus.

FIG. 25 is a flowchart describing an example of a flow of decoding processing.

FIG. 26 is a block diagram illustrating a main configuration example of a computer.

### MODE FOR CARRYING OUT THE INVENTION

Modes for carrying out the present disclosure (hereinafter, referred to as embodiments) will be described below. Note that the description will be given in the following order.
1. Encoding of sensor data by LiDAR of dToF method
2. Sorting based on signal intensity
3. First embodiment (sorting based on threshold value)
4. Second embodiment (sorting by function model)
5. Third embodiment (sorting by threshold value and function model)
6. Supplementary note

### 1. Encoding of Sensor Data by LiDAR of dToF Method

### <Documents or the Like Supporting Technical Content/Technical Terms>

The scope disclosed in the present technology includes not only the content described in the embodiments but also the content described in the following non-patent documents and the like that are known at the time of filing, content of other documents referred to in the following non-patent documents, and the like.
Non-Patent Document 1: (described above)
Patent Document 1: (described above)

That is, the content described in the above-described Non Patent Documents, the content of other documents referred to in the above-described Non Patent Documents, and the like are also basis for determining the support requirement.

<LiDAR data>

Conventionally, there is LiDAR (light detection and ranging) data obtained by measuring scattered light with respect to light irradiation with a dToF (direct Time of Flight) method for example, and by analyzing a distance to a target at a long distance and a property of the target.

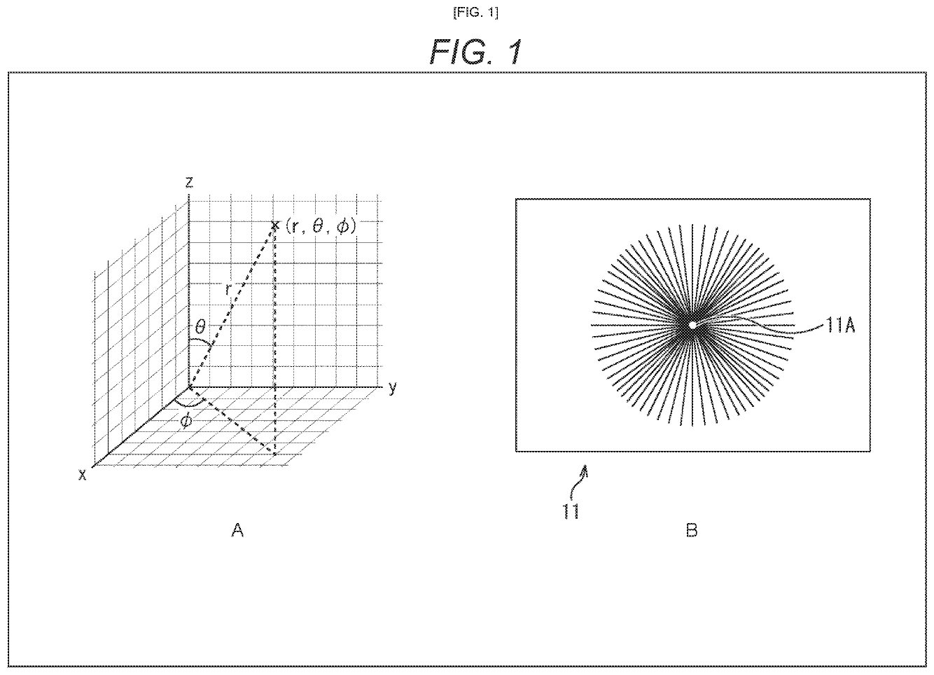

In a case where LiDAR data is generated, for example, linear scanning is performed while changing an angle θ in a polar coordinate system as illustrated in A of FIG. 1. In a case of the polar coordinate system, a three-dimensional position is represented by a distance r from a reference point (origin), an angle φ in a horizontal direction (on an X-Y plane), and an angle θ from a z axis (perpendicular to the X-Y plane) as illustrated in A of FIG. 1. While changing @ in the polar coordinate system, such scanning is repeated to scan an entire circumference. By performing scanning with such a procedure, LiDAR data 11 indicating a result of detecting a body around an observation point 11A as illustrated in B of FIG. 1 is generated.

For example, when reflection intensity of an object in a real space is measured by such a sensor, the reflection intensity for each three-dimensional position is obtained as sensor data. That is, the reflection intensity distribution in the 3D space (data of a three-dimensional structure) is obtained.

### <2D Encoding>

Because such data having a three-dimensional structure (hereinafter, also referred to as 3D data) generally has a large amount of information, it is required to compress (encode) the data. There has been considered a method for converting 3D data to data having a two-dimensional structure (hereinafter, also referred to as 2D data) by dividing 3D data by a plane to achieve a high compression rate by applying a 2D encoding method, which is an encoding method for 2D data (image).

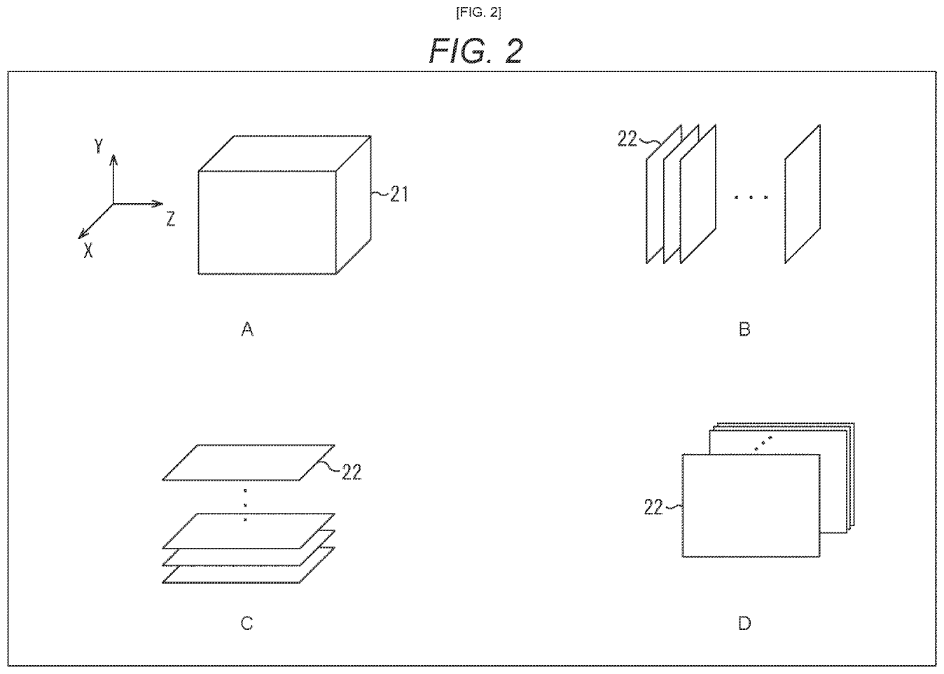

For example, 3D data 21 having a three-dimensional structure as illustrated in A of FIG. 2 can be converted to a plurality of pieces of 2D data 22 by being divided in a Z-axis direction as illustrated in B of FIG. 2, in a Y-axis direction as illustrated in C of FIG. 2, and in an X-axis direction as illustrated in D of FIG. 2.

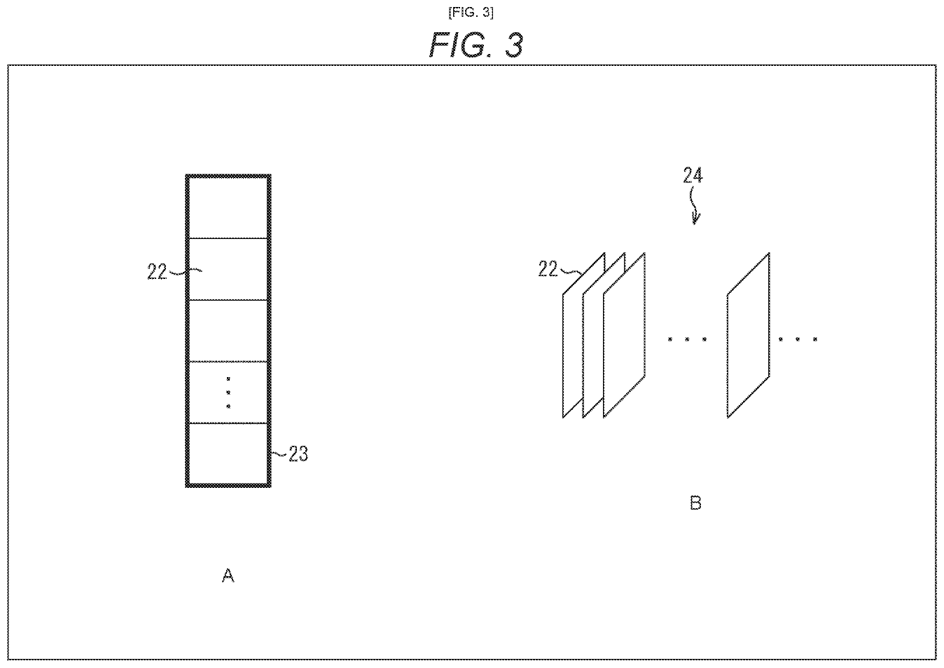

For example, the plurality of pieces of 2D data 22 may be arranged on a plane, combined, and subjected to 2D encoding into a piece of 2D data 23, as illustrated in A of FIG. 3. Furthermore, the plurality of pieces of 2D data 22 may be arranged in a time axis direction as illustrated in B of FIG. 3, for example, and may be subjected to 2D encoding as a moving image 24.

Because 2D encoding can be applied in this manner, improvement in encoding efficiency can be expected. Furthermore, it is possible to implement the system at low cost, and reduce an increase in costs.

<Sensor Data by LiDAR of dToF Method>

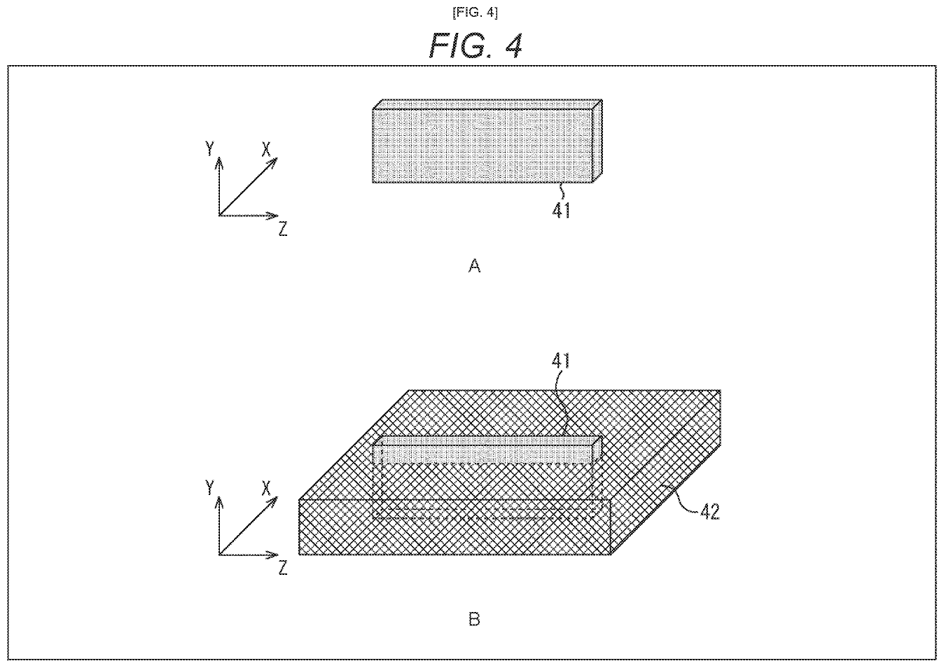

It is assumed that the real space is sensed by using such a LiDAR sensor to obtain the reflection intensity distribution in the 3D space. For example, as illustrated in A of FIG. 4, in a case where there is an object 41 having a cuboid shape in a three-dimensional space (XYZ space), as a result of the sensing, ideally, a large reflection intensity is obtained only at a position of the object 41 (there is no reflection intensity at another position).

B of FIG. 4 is a diagram illustrating a relation between the object 41 and various noise components 42 due to external light or the like. As illustrated in B of FIG. 4, in practice, the noise components 42 are distributed in an entire 3D space, and the reflection intensity due to the object 41 is buried by other noise components 42.

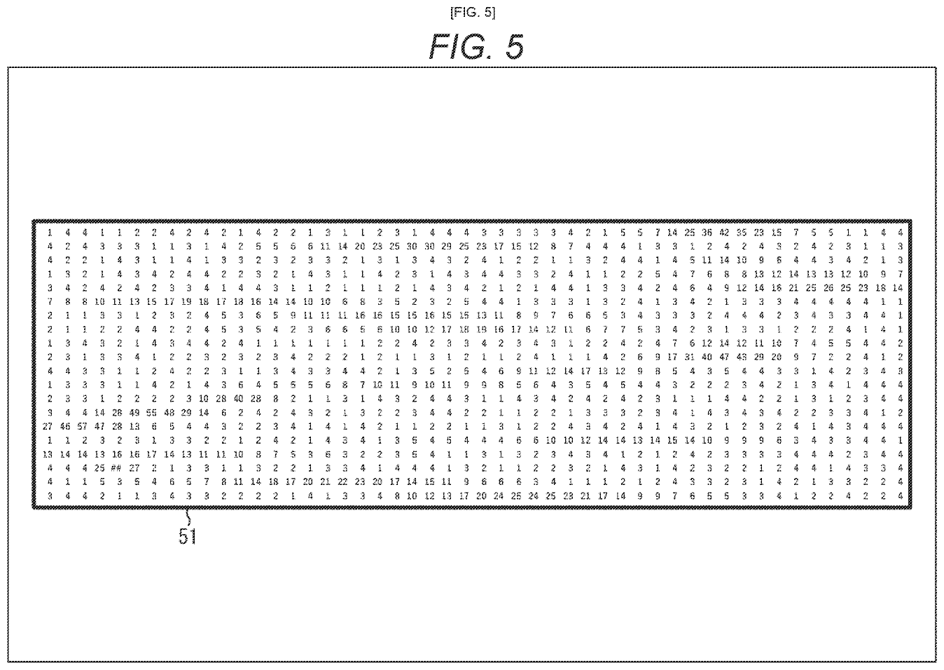

Therefore, even if data is converted to 2D data as in the examples in FIG. 2, non-zero coefficients are distributed over an entire 2D data 51 as illustrated in FIG. 5. That is, because random signal components increase, there is possibility that encoding efficiency of the 2D data 51 decreases. Therefore, there is a possibility that a load of encoding processing or decoding processing unnecessarily increases. For example, in a case of sensor data illustrated in B of FIG. 4, even if only the reflection intensity due to the object 41 is required, the noise components 42 also need be encoded/decoded.

On the other hand, it is conceivable to remove the noise components 42 and encode/decode only the reflection intensity due to the object 41, but it is difficult to completely correctly separate the reflection intensity due to the object 41 and the noise components 42. Furthermore, it is also conceivable that necessary information changes depending on the application. For example, depending on the application, there may be a case where the noise components 42 also include necessary information. Therefore, it is not preferable to unnecessarily delete information.

Then, methods described in Non-Patent Document 1 and Non-Patent Document 2 do not support scalable decoding, and scalable decoding is difficult to achieve.

### 2. Sorting Based on Signal Intensity

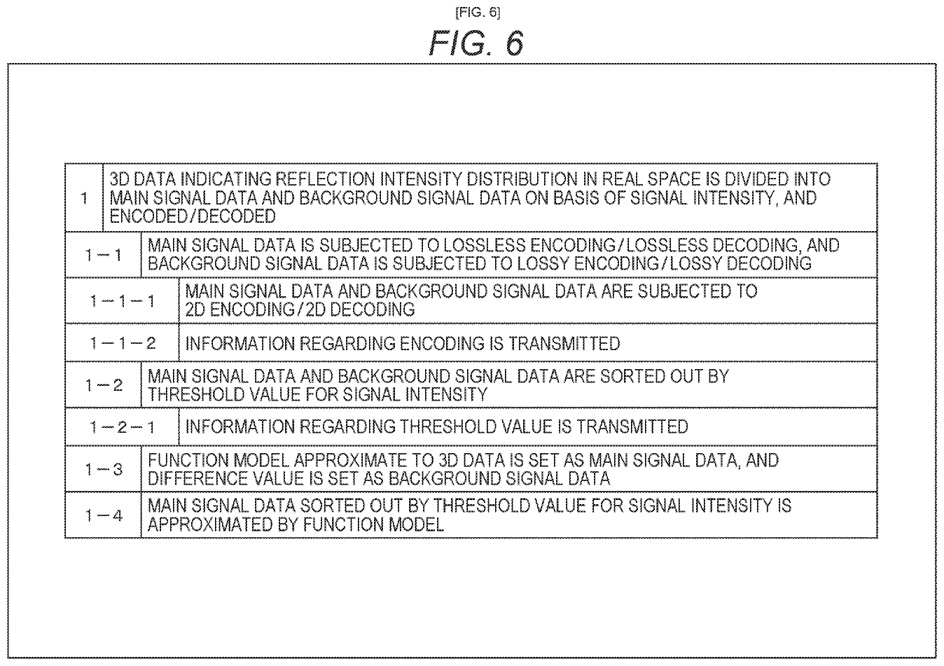

Therefore, as illustrated in the top row of the table in FIG. 6, 3D data indicating a reflection intensity distribution in a real space is divided into main signal data and background signal data on the basis of signal intensity, and encoded/decoded (Method 1).

For example, in an image processing method, 3D data having a three-dimensional structure and detected in a real space is sorted into main signal data and background signal data on the basis of signal intensity, and
each of the sorted main signal data and the background signal data are encoded to generate coded data.

For example, in an image processing apparatus, there are included a sorting unit that sorts, on the basis of a signal intensity, a 3D data having a three-dimensional structure and detected in a real space, into a main signal data and a background signal data, and an encoding unit that encodes each of the main signal data and the background signal data that are sorted out by the sorting unit, to generate coded data.

For example, in the image processing method, coded data of each of main signal data and background signal data that are obtained by sorting, on the basis of signal intensity, 3D data having a three-dimensional structure and detected in a real space is decoded to generate the main signal data and the background signal data, and the generated main signal data and background signal data are combined to generate the 3D data.

For example, in the image processing apparatus, there are included a decoding unit that decodes coded data of each of main signal data and background signal data that are obtained by sorting, on the basis of signal intensity, 3D data having a three-dimensional structure and detected in a real space, to generate the main signal data and the background signal data, and a combining unit that combines the main signal data and the background signal data that are generated by the decoding unit, to generate the 3D data.

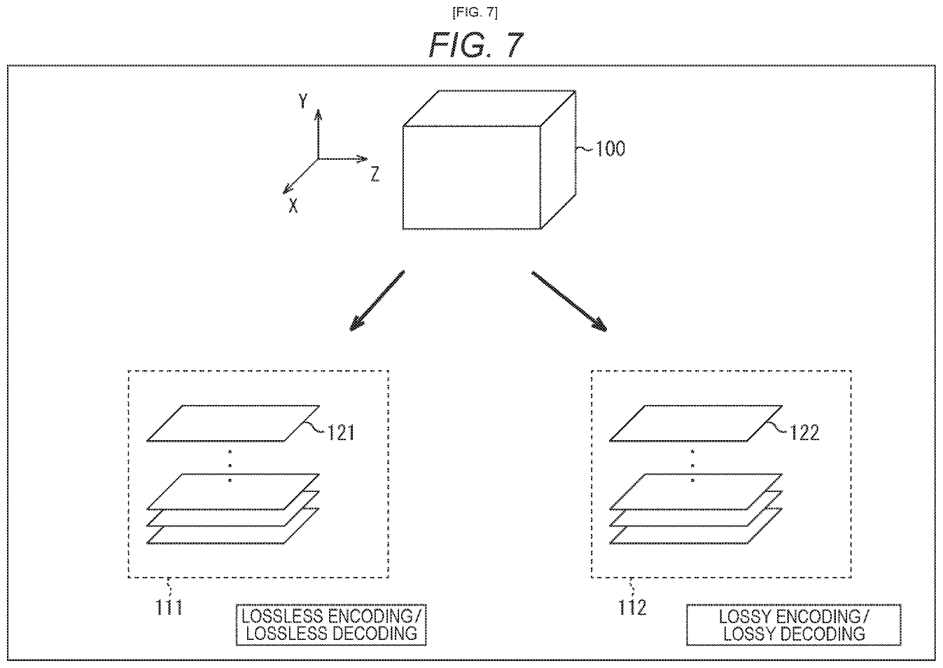

For example, as illustrated in FIG. 7, an encoder sorts 3D data 100 detected in the real space into main signal data 111 and background signal data 112 on the basis of the signal intensity, and encodes each of the main signal data 111 and the background signal data 112. For example, the encoder may encode the main signal data 111 and the background signal data 112 such that the main signal data 111 can be decoded independently of the background signal data 112. Furthermore, the encoder may encode the main signal data 111 and the background signal data 112 independently of each other.

A decoder decodes and combines the coded data of each of the main signal data 111 and the background signal data 112 to generate (restore) the 3D data 100. For example, the decoder may decode only the main signal data 111 if the main signal data 111 can be decoded independently of the background signal data 112. Furthermore, in a case where the main signal data 111 and the background signal data 112 are encoded independently of each other, the decoder may decode only the main signal data 111 or may decode only the background signal data 112. Moreover, in this case, the decoder may decode the background signal data 112 after decoding the main signal data 111, may decode the main signal data 111 after decoding the background signal data 112, or may decode the main signal data 111 and the background signal data 112 in parallel.

With this arrangement, it is possible to scalably decode coded data of 3D data having a three-dimensional structure and detected in the real space. In the present disclosure, the scalable decoding includes not only independently decoding a part of coded data but also possibly controlling an order of decoding the coded data.

Such control can be performed on the basis of any circumstances such as band limitation of a transmission path, processing capability of a decoding apparatus, or application of decoded data, for example.

For example, in a case where there is no sufficient transmission path bandwidth or processing capability of the decoder, the decoder may decode the coded data of the main signal data and omit the decoding of the coded data of the background signal data. Furthermore, for example, in a case where it is desired to process only the main signal data such as data of intensity of reflection by an object in the real space, the decoder may decode the coded data of the main signal data and omit the decoding of the coded data of the background signal data. On the other hand, in a case where background signal data such as data of external light is also desired to be processed, the decoder may decode both the coded data of the main signal data and the coded data of the background signal data. Moreover, for example, in order to speed up data display or produce performance, the decoder may first decode the coded data of the more important main signal and then decode the coded data of the background signal data.

With this arrangement, the decoder can decode in a more appropriate method for more various situations.

Note that the 3D data may include any information. For example, the 3D data may be a reflection intensity distribution detected in the real space. For example, the reflection intensity distribution may be sensor data detected by the dToF LiDAR sensor as described above.

Furthermore, the main signal data and the background signal data may be encoded at different compression rates. For example, the compression rate of the encoding of the background signal data may be higher than the compression rate of the encoding of the main signal data.

For example, as illustrated in the second row from the top of the table in FIG. 6, the sorted out main signal data may be subjected to lossless encoding, and the coded data of the main signal data may be subjected to lossless decoding. Furthermore, the sorted out background signal data may be subjected to lossy encoding, and the coded data of the background signal data may be subjected to lossy decoding (Method 1-1). For example, in FIG. 7, the sorted out main signal data 111 may be subjected to lossless encoding/lossless decoding, and the sorted out background signal data 112 may be subjected to lossy encoding/lossy decoding. Any lossless encoding/lossless decoding may be applied as long as the methods are lossless methods and correspond to each other. Furthermore, any lossy encoding/lossy decoding may be applied as long as the methods are lossy methods and correspond to each other.

With this arrangement, it is possible to reduce an amount of encoding the background signal data while preventing an information amount of the main signal data having higher importance than the background signal data from decreasing. That is, it is possible to reduce a decrease in encoding efficiency without reducing more important information. That is, it is possible to reduce a decrease in encoding efficiency while reducing a decrease in image quality as data.

For example, a target bit rate may be set, and the background signal may be subjected to lossy encoding by a difference between the target bit rate and a bit rate of the coded data of the main signal subjected to the lossless encoding. With this arrangement, the bit rate of the coded data of the 3D data can be controlled.

Furthermore, as illustrated in the third row from the top of the table in FIG. 6, the main signal data and the background signal data may be encoded by a 2D encoding method. Hereinafter, encoding by a 2D encoding method is also referred to as 2D encoding. Furthermore, the coded data of the main signal data and the background signal data may be decoded by a 2D decoding method (a decoding method corresponding to a 2D encoding method applied to the encoding) that is a decoding method for the 2D data (for images). Hereinafter, decoding by a 2D decoding method is also referred to as 2D decoding. The 2D encoding method applied to 2D encoding (2D decoding method applied to 2D decoding) may be any encoding method (decoding method) as long as the method is for 2D data. For example, the encoding method may be an encoding method (decoding method) for a still image or a coding method (decoding method) for a moving image.

For example, each of the main signal data and background signal data including 3D data may be converted to (a plurality of pieces of) 2D data having a two-dimensional structure, and each of the main signal data and background signal data including (a plurality of pieces of) 2D data may be subjected to 2D encoding. Furthermore, the coded data of each of the main signal data and background signal data including (a plurality of pieces of) 2D data may be subjected to 2D decoding, and the obtained main signal data and background signal data including 2D data may be converted to 3D data (Method 1-1-1). Hereinafter, converting 3D data to (a plurality of pieces of) 2D data is also referred to as 3D-2D conversion. Furthermore, converting (a plurality of pieces of) 2D data to 3D data is also referred to as 2D-3D conversion. Methods for the 3D-2D conversion and 2D-3D conversion are arbitrary as long as the methods correspond to each other. For example, a method described with reference to FIG. 2 may be applied.

For example, as illustrated in FIG. 7, the encoder may perform 3D-2D conversion on the main signal data 111 to 2D data 121, and perform 2D encoding on the obtained 2D data 121. In this case, the decoder performs 2D decoding on the coded data of the 2D data 121, and performs 2D-3D conversion on the obtained 2D data 121. Furthermore, the encoder may perform 3D-2D conversion on the background signal data 112 to 2D data 122, and perform 2D encoding on the obtained 2D data 122. In this case, the decoder performs 2D decoding on the coded data of the 2D data 122, and performs 2D-3D conversion on the obtained 2D data 122. Methods for the 2D-3D conversion and 3D-2D conversion are arbitrary. For example, the conversion may be performed by a method described with reference to FIG. 2.

With this arrangement, it is possible to apply inexpensive 2D encoding/2D decoding, and thus, it is possible to reduce an increase in costs. Furthermore, encoding can be performed at a higher compression rate. Moreover, it is possible to reduce an increase in load or processing time of the encoding/decoding.

Furthermore, an encoding method and decoding method of the main signal data and the background signal data are arbitrary. These encoding method/decoding method may be predetermined, or an encoding method/decoding method selected from a plurality of candidates on the basis of an arbitrary condition or the like may be applied.

As illustrated in the fourth row from the top of the table in FIG. 6, information regarding encoding may be in association with the coded data and be transmitted from the encoder to the decoder (Method 1-1-2). For example, the encoder may add, to the coded data, meta information including the encoding method applied to encoding of the main signal data and the encoding method applied to encoding of the background signal data. Then, the decoder may decode the coded data of each of the main signal data and the background signal data by using the decoding method corresponding to the encoding method for each of the main signal data and the background signal data that are included in the meta information added to the coded data.

With this arrangement, the decoder can easily acquire information applied to the encoding. Therefore, on the basis of the information, the decoder can more easily perform decoding corresponding to the encoding. In other words, more various encoding methods/decoding methods can be applied.

### 3. First Embodiment

### <Sorting Based on Threshold Value>

Note that a method for sorting into main signal data and background signal data is arbitrary. For example, as illustrated in the fifth row from the top of the table in FIG. 6, main signal data and background signal data may be sorted out by a threshold value for signal intensity (Method 1-2).

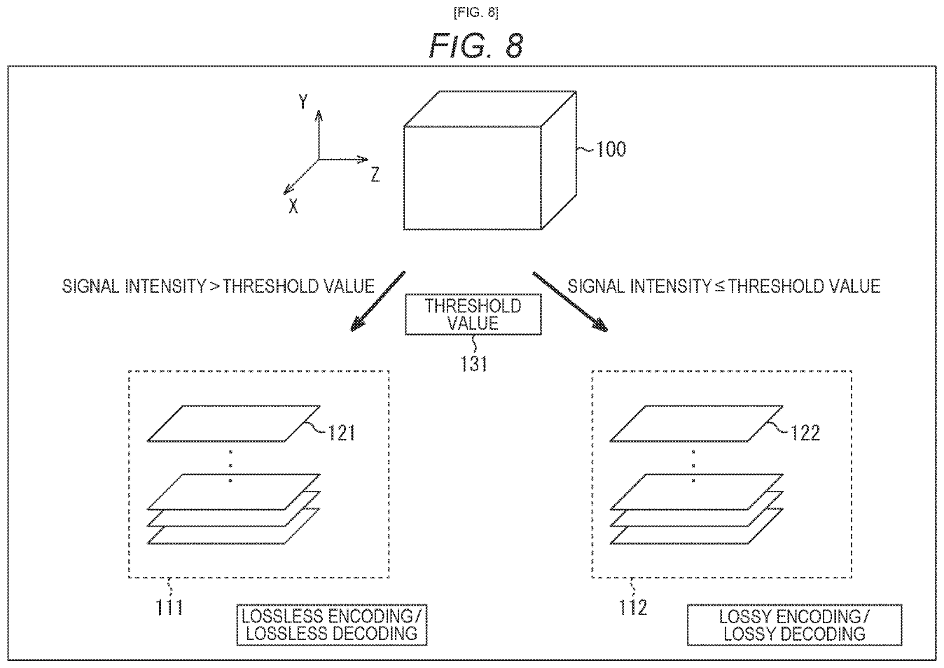

For example, as illustrated in FIG. 8, an encoder may sort 3D data 100 into data having signal intensity greater than a predetermined threshold value 131 as main signal data 111, and data having signal intensity equal to or smaller than the predetermined threshold value 131 as background signal data 112. Furthermore, a decoder may combine the main signal data and the background signal data by using a predetermined threshold value for the 3D data.

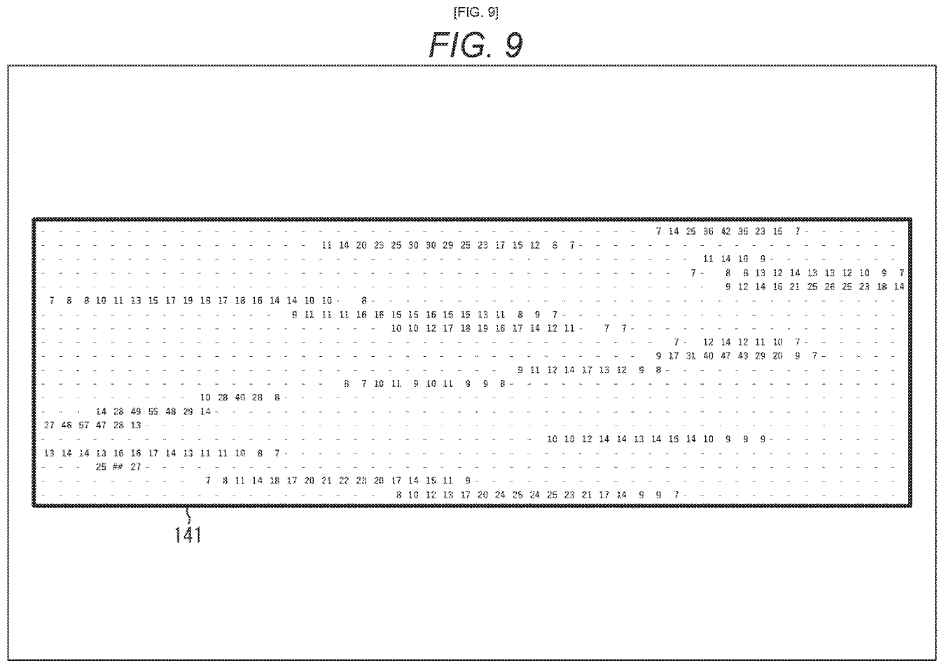

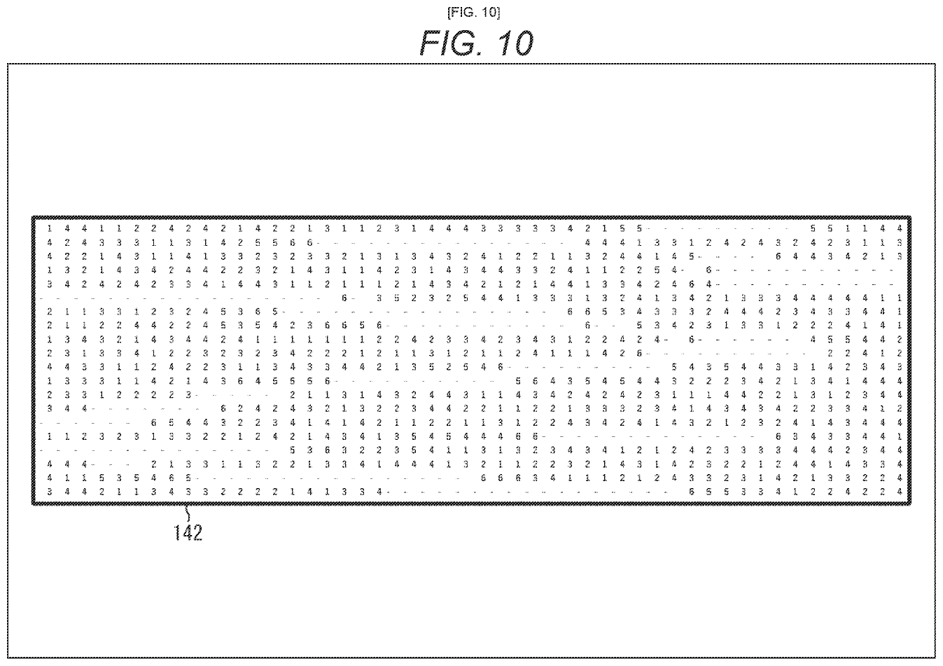

For example, 2D data 51 illustrated in FIG. 5 can be sorted by using a predetermined threshold value into main signal data 141 as illustrated in FIG. 9 and background signal data 142 as illustrated in FIG. 10. With this arrangement, easy sorting into the main signal data and the background signal data is possible.

Note that this threshold value may be any value. For example, the threshold value may be a predetermined value or a value set by an encoder or the like at a time of encoding. Furthermore, the threshold value may be a fixed value or may be variable with respect to an entire 3D data to be sorted. For example, different values may be applied locally. In a case where a threshold value is set at the time of encoding, as illustrated in the sixth row from the top of the table in FIG. 6, information regarding the threshold value may be transmitted from the encoder to the decoder (Method 1-2-1). For example, the encoder may add, to coded data, meta information including information indicating a threshold value. Furthermore, the decoder may combine the main signal data and the background signal data by using the threshold value included in the meta information added to the coded data.

### <Encoding Apparatus>

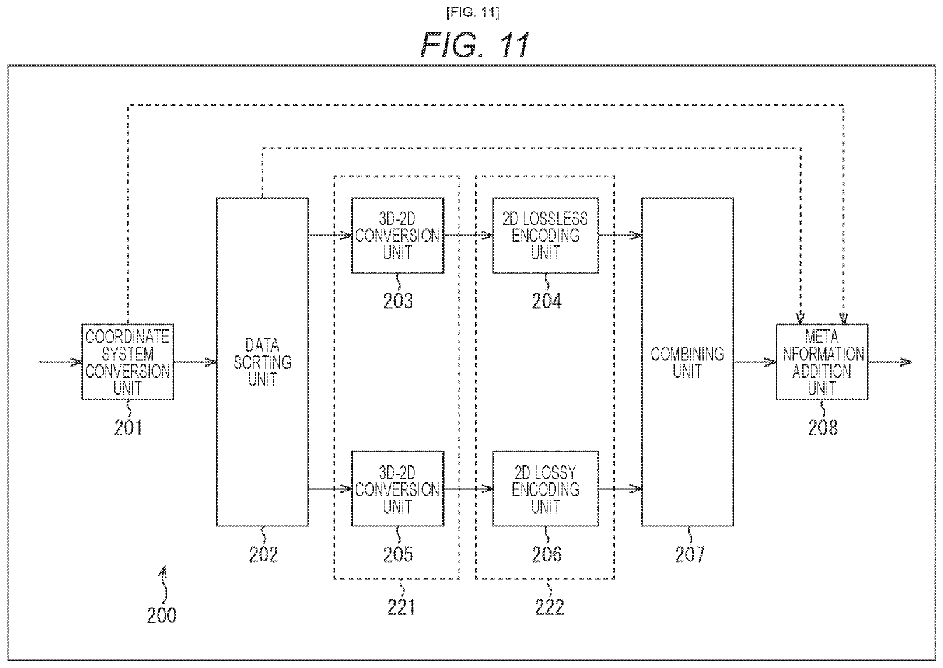

FIG. 11 is a block diagram of this case, the block diagram illustrating an example of a configuration of an encoding apparatus that is an embodiment of an image processing apparatus to which the present technology is applied. An encoding apparatus 200 illustrated in FIG. 11 is an apparatus that encodes 3D data having a three-dimensional structure and detected in a real space, such as the LiDAR data described above. For example, the encoding apparatus 200 can encode 3D data by applying the present technology described in the present embodiment.

Note that, in FIG. 11, main parts of processing units, data flows, and the like are illustrated, and those illustrated in FIG. 11 are not necessarily all. That is, in the encoding apparatus 200, there may be a processing unit not illustrated as a block in FIG. 11, or there may be a flow of processing or data not illustrated as an arrow or the like in FIG. 11.

As illustrated in FIG. 11, the encoding apparatus 200 includes a coordinate system conversion unit 201, a data sorting unit 202, a 3D-2D conversion unit 203, a 2D lossless encoding unit 204, a 3D-2D conversion unit 205, a 2D lossy encoding unit 206, a combining unit 207, and a meta information addition unit 208. The 3D-2D conversion unit 203 and the 3D-2D conversion unit 205 may be regarded as a 3D-2D conversion unit 221 in the present disclosure. Furthermore, the 2D lossless encoding unit 204 and the 2D lossy encoding unit 206 may be regarded as an encoding unit 222 in the present disclosure.

The coordinate system conversion unit 201 acquires 3D data in a polar coordinate system input to the encoding apparatus 200. This 3D data is 3D data having a three-dimensional structure and detected in a real space by, for example, a LiDAR sensor of a dToF method, or the like. The coordinate system conversion unit 201 converts a coordinate system of the 3D data from the polar coordinate system to an orthogonal coordinate system. The coordinate system conversion unit 201 supplies the generated 3D data in the orthogonal coordinate system to the data sorting unit 202. Furthermore, the coordinate system conversion unit 201 may supply the meta information addition unit 208 with information regarding the conversion of the coordinate system. Note that, in a case where the coordinate system of the 3D data input to the encoding apparatus 200 is an orthogonal coordinate system, this processing is omitted.

The data sorting unit 202 acquires the 3D data in the orthogonal coordinate system supplied from the coordinate system conversion unit 201. The data sorting unit 202 sorts the acquired 3D data into the main signal data and the background signal data. Note that, as described above in <Sorting based on threshold value>, the sorting method is arbitrary. For example, the data sorting unit 202 may sort the 3D data into the main signal data and the background signal data by using a threshold value for the signal intensity. In this case, for example, the data sorting unit 202 may sort out the 3D data having signal intensity greater than a predetermined threshold value as main signal data, and sort out the 3D data having signal intensity equal to or smaller than the threshold value as background signal data. The data sorting unit 202 supplies the sorted out main signal data to the 3D-2D conversion unit 203. Furthermore, the data sorting unit 202 supplies the sorted out background signal data to the 3D-2D conversion unit 205. Moreover, the data sorting unit 202 may supply the meta information addition unit 208 with information regarding data sorting (for example, a threshold value or the like) of the data. Note that, as described above in <Sorting based on threshold value>, the threshold value applied by the data sorting unit 202 may be any value.

The 3D-2D conversion unit 203 acquires the main signal data supplied from the data sorting unit 202. The main signal data is 3D data having a three-dimensional structure. The 3D-2D conversion unit 203 performs 3D-2D conversion on the acquired main signal data of 3D data. The main signal data subjected to the 3D-2D conversion is 2D data having a two-dimensional structure. The 3D-2D conversion unit 203 supplies the main signal data of 2D data to the 2D lossless encoding unit 204. A method for the 3D-2D conversion is arbitrary. For example, the conversion may be performed by a method described with reference to FIG. 2.

The 2D lossless encoding unit 204 acquires the main signal data supplied from the 3D-2D conversion unit 203. The main signal data is 2D data having a two-dimensional structure. The 2D lossless encoding unit 204 performs, with a lossless method, 2D encoding on the main signal data to generate coded data. As described above in <2. Sorting based on signal intensity>, the encoding method of this 2D encoding may be any encoding method as long as the encoding method is a lossless encoding method and is a 2D encoding method. The 2D lossless encoding unit 204 supplies coded data of the generated main signal data to the combining unit 207.

The 3D-2D conversion unit 205 acquires the background signal data supplied from the data sorting unit 202. The background signal data is 3D data having a three-dimensional structure. The 3D-2D conversion unit 205 performs 3D-2D conversion on the acquired background signal data of 3D data. The background signal data subjected to the 3D-2D conversion is 2D data having a two-dimensional structure. The 3D-2D conversion unit 205 supplies the background signal data of 2D data to the 2D lossy encoding unit 206. A method for the 3D-2D conversion is arbitrary. For example, the conversion may be performed by a method described with reference to FIG. 2.

The 2D lossy encoding unit 206 acquires the background signal data supplied from the 3D-2D conversion unit 205. The background signal data is 2D data having a two-dimensional structure. The 2D lossy encoding unit 206 performs, with a lossy method, 2D encoding on the background signal data to generate coded data. As described above in <2. Sorting based on signal intensity>, the encoding method of this 2D encoding may be any encoding method as long as the encoding method is a lossy encoding method and is a 2D encoding method. The 2D lossy encoding unit 206 supplies coded data of the generated background signal data to the combining unit 207.

The combining unit 207 acquires the coded data of the main signal data supplied from the 2D lossless encoding unit 204 and the coded data of the background signal data supplied from the 2D lossy encoding unit 206. The combining unit 207 combines those acquired coded data to generate one piece of coded data (one bitstream). A method for combining the coded data is arbitrary. The combining unit 207 supplies the generated coded data (bitstream) to the meta information addition unit 208.

The meta information addition unit 208 acquires the coded data (bitstream) supplied from the combining unit 207. The meta information addition unit 208 adds meta information to the acquired coded data. For example, the meta information addition unit 208 may acquire information regarding coordinate system conversion supplied from the coordinate system conversion unit 201, and add the information to the coded data as the meta information. Furthermore, the meta information addition unit 208 may acquire information regarding data sorting supplied from the data sorting unit 202, and add the information to the coded data as the meta information. Note that content of the meta information added to the coded data is arbitrary. The meta information may include information other than information regarding the coordinate system conversion and information regarding data sorting. For example, as described above in <2. Sorting based on signal intensity>, information regarding encoding may be included in the meta information. To outside of the encoding apparatus 200, the meta information addition unit 208 outputs the coded data (bitstream) to which the meta information is added. The coded data (bitstream) is transmitted to a decoding apparatus via a transmission path, a recording medium, another apparatus, or the like, for example.

That is, the 3D-2D conversion unit 221 converts, to 2D data, each of the main signal data and the background signal data that are obtained by sorting, on the basis of the signal intensity, the 3D data having a three-dimensional structure and detected in the real space. The encoding unit 222 encodes each of the main signal data and the background signal data that are obtained by sorting, on the basis of the signal intensity, the 3D data having a three-dimensional structure and detected in the real space, to generate coded data. For example, the 3D-2D conversion unit 221 converts each of the main signal data and background signal data of 3D data supplied from the data sorting unit 202 to 2D data, and supplies the 2D data to the encoding unit 222. Furthermore, the encoding unit 222 encodes, with a 2D encoding method, each of the main signal data and background signal data of 2D data supplied from the 3D-2D conversion unit 221, to generate coded data. The encoding unit 222 supplies the generated coded data of each of the main signal data and the background signal data to the combining unit 207.

With the above configuration, on the basis of the signal intensity, the encoding apparatus 200 can sort the 3D data having a three-dimensional structure and detected in the real space into the main signal data and the background signal data, and encode the main signal data and the background signal data. Therefore, the decoding apparatus can scalably decode the coded data of 3D data having a three-dimensional structure and detected in the real space.

### <Flow of Encoding Processing>

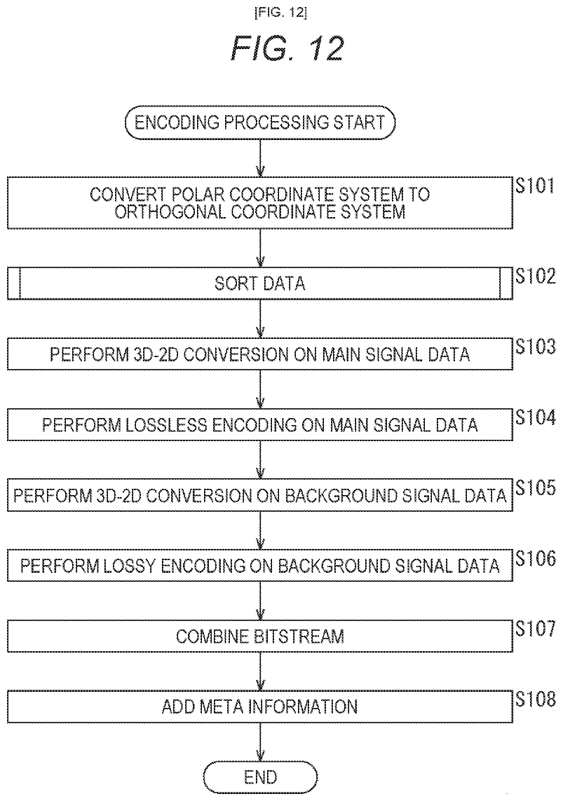

An example of a flow of encoding processing executed by the encoding apparatus 200 will be described with reference to the flowchart in FIG. 12.

When the encoding processing is started, the coordinate system conversion unit 201 in the encoding apparatus 200 converts the coordinate system of 3D data from the polar coordinate system to the orthogonal coordinate system in Step S101.

In Step S102, the data sorting unit 202 executes sorting processing to sort the 3D data in the orthogonal coordinate system obtained in the processing in Step S101 into the main signal data and the background signal data.

In Step S103, the 3D-2D conversion unit 203 performs 3D-2D conversion on the main signal data of 3D data sorted out in the processing in Step S102.

In Step S104, the 2D lossless encoding unit 204 encodes, with a lossless 2D encoding method, the main signal data of 2D data obtained in the processing in Step S103, to generate coded data of the main signal data.

In Step S105, the 3D-2D conversion unit 205 performs 3D-2D conversion on the background signal data of 3D data sorted out in the processing in Step S102.

In Step S106, the 2D lossy encoding unit 206 encodes, with a lossy 2D encoding method, the background signal data of 2D data obtained in the processing in Step S105, to generate coded data of the background signal data.

In Step S107, the combining unit 207 combines the coded data of the main signal data generated in the processing in Step S104 and the coded data of the background signal data generated in the processing in Step S106, to generate one bitstream (coded data of the 3D data detected in the real space).

In Step S108, the meta information addition unit 208 adds meta information including information regarding coordinate system conversion for example, or information regarding data sorting, such as a threshold value for example, to the bitstream generated in the processing in Step S107.

When the processing in Step S108 ends, the encoding processing ends.

### <Flow of Sorting Processing>

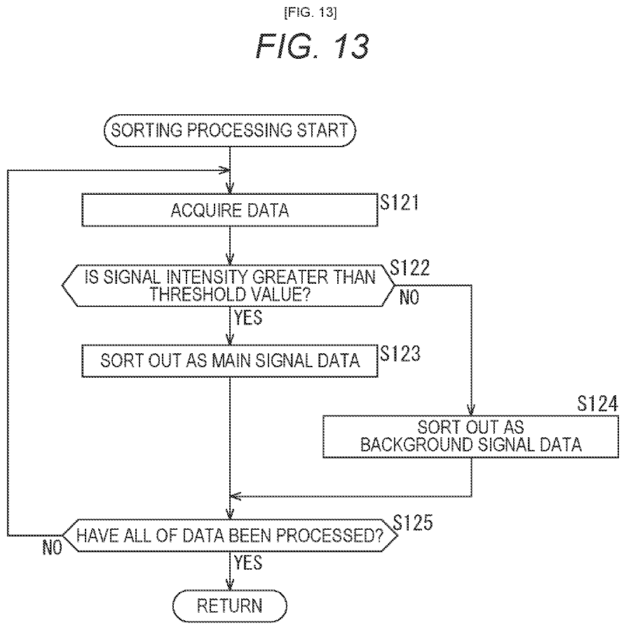

An example of a flow of the sorting processing executed in Step S102 in FIG. 12 is described with reference to the flowchart in FIG. 13.

When the sorting processing is started, in Step S121, the data sorting unit 202 acquires, for each unit of processing, the 3D data in the orthogonal coordinate system obtained in the processing in Step S101. For example, the data sorting unit 202 acquires signal intensities included in the 3D data one by one.

In Step S122, the data sorting unit 202 determines whether or not signal intensity in the 3D data acquired in Step S121 is greater than a threshold value. In a case where it is determined that the signal intensity is greater than the threshold value, the processing proceeds to Step S123.

In Step S123, the data sorting unit 202 sorts the 3D data into the main signal data. When the processing in Step S123 ends, the processing proceeds to Step S125.

Furthermore, in a case where it is determined in Step S122 that the signal intensity in the 3D data is equal to or smaller than the threshold value, the processing proceeds to Step S124.

In Step S124, the data sorting unit 202 sorts the 3D data into the background signal data. When the processing in Step S124 ends, the processing proceeds to Step S125.

In Step S125, the data sorting unit 202 determines whether or not all of the data (of the 3D data to be sorted) have been processed. In a case where it is determined that there is unprocessed data, the processing returns to Step S121 and the subsequent processing is executed. In a case where it is determined in Step S125 that all the data have been processed, the sorting processing ends, and the processing returns to FIG. 12.

By executing each processing as described above, on the basis of the signal intensity, the encoding apparatus 200 can sort the 3D data having a three-dimensional structure and detected in the real space into the main signal data and the background signal data, and encode the main signal data and the background signal data. Therefore, the decoding apparatus can scalably decode the coded data of 3D data having a three-dimensional structure and detected in the real space.

### <Decoding Apparatus>

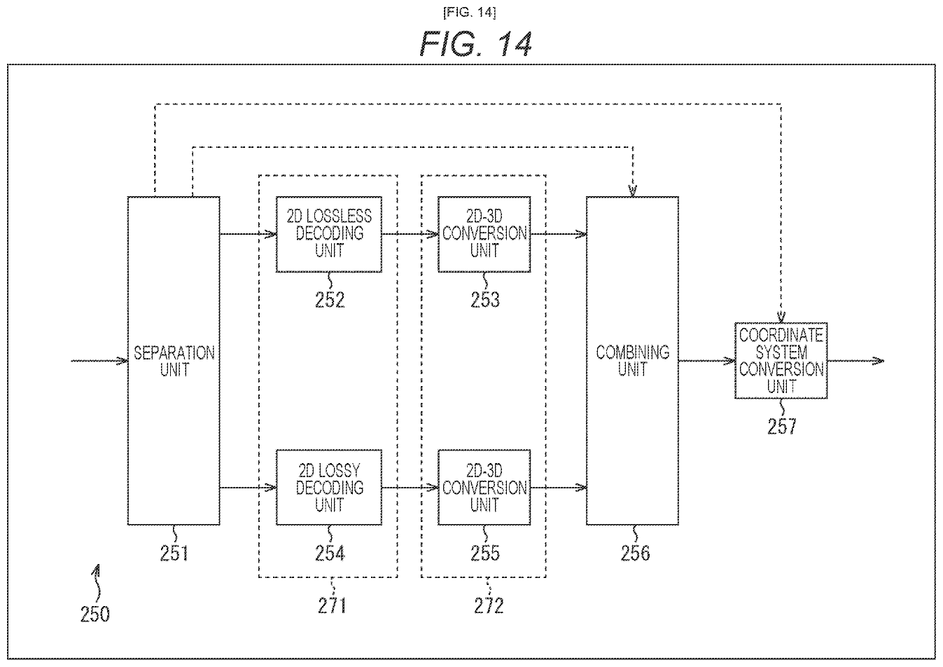

FIG. 14 is a block diagram of this case, the block diagram illustrating an example of a configuration of a decoding apparatus that is an embodiment of an image processing apparatus to which the present technology is applied. A decoding apparatus 250 illustrated in FIG. 14 is an apparatus that decodes the coded data of the 3D data generated by the above-described encoding apparatus 200 and detected in the real space. For example, the decoding apparatus 250 can decode the coded data of the 3D data by applying the present technology described in the present embodiment.

Note that, in FIG. 14, main parts of processing units, data flows, and the like are illustrated, and those illustrated in FIG. 14 are not necessarily all. That is, in the decoding apparatus 250, there may be a processing unit not illustrated as a block in FIG. 14, or there may be a flow of processing or data not illustrated as an arrow or the like in FIG. 14.

As illustrated in FIG. 14, the decoding apparatus 250 includes a separation unit 251, a 2D lossless decoding unit 252, a 2D-3D conversion unit 253, a 2D lossy decoding unit 254, a 2D-3D conversion unit 255, a combining unit 256, and a coordinate system conversion unit 257. The 2D lossless decoding unit 252 and the 2D lossy decoding unit 254 may be regarded as a decoding unit 271 in the present disclosure. Furthermore, the 2D-3D conversion unit 253 and the 2D-3D conversion unit 255 may be regarded as a 2D-3D conversion unit 272 in the present disclosure.

The separation unit 251 acquires the coded data (bitstream) of the 3D data input to the decoding apparatus 250. The separation unit 251 parses the acquired bitstream and separates the bitstream into the coded data of the main signal data, the coded data of the background signal data, and the meta information. In other words, the separation unit 251 extracts these pieces of information from the bitstream. The separation unit 251 supplies the coded data of the extracted main signal data to the 2D lossless decoding unit 252. Furthermore, the separation unit 251 supplies the coded data of the extracted background signal data to the 2D lossy decoding unit 254. Moreover, in a case where the extracted meta information includes information regarding data sorting (for example, a threshold value or the like), the separation unit 251 may supply the combining unit 256 with the information regarding the data sorting. Furthermore, in a case where the extracted meta information includes information regarding coordinate system conversion, the separation unit 251 may supply the coordinate system conversion unit 257 with the information regarding the coordinate system conversion.

The 2D lossless decoding unit 252 acquires the coded data of the main signal data supplied from the separation unit 251. The 2D lossless decoding unit 252 performs, with a lossless method, 2D decoding on the acquired coded data of the main signal data to generate (restore) the main signal data of 2D data. As described above in <2. Sorting based on signal intensity>, this decoding method of the 2D decoding may be any decoding method as long as the decoding method is a decoding method (a lossless decoding method, and a 2D decoding method) corresponding to an encoding method applied to encoding of main signal data. For example, as described above in <2. Sorting based on signal intensity>, the decoding method may be a decoding method corresponding to an encoding method specified by the information regarding encoding included in the meta information. The 2D lossless decoding unit 252 supplies the main signal data to the 2D-3D conversion unit 253.

The 2D-3D conversion unit 253 acquires the main signal data supplied from the 2D lossless decoding unit 252. The main signal data is 2D data having a two-dimensional structure. The 2D-3D conversion unit 253 performs 2D-3D conversion on the acquired main signal data of 2D data. The main signal data subjected to the 2D-3D conversion is 3D data having a three-dimensional structure. The 2D-3D conversion unit 253 supplies the main signal data of 3D data to the combining unit 256. A method for the 2D-3D conversion is arbitrary. For example, inverse conversion of the 3D-2D conversion as described with reference to FIG. 2 may be used.

The 2D lossy decoding unit 254 acquires the coded data of the background signal data supplied from the separation unit 251. The 2D lossy decoding unit 254 performs, with a lossy method, 2D decoding on the coded data of the acquired background signal data to generate (restore) the background signal data of 2D data. As described above in <2. Sorting based on signal intensity>, this decoding method of the 2D decoding may be any decoding method as long as the decoding method is a decoding method (a lossy decoding method, and a 2D decoding method) corresponding to an encoding method applied to encoding of background signal data. For example, as described above in <2. Sorting based on signal intensity>, the decoding method may be a decoding method corresponding to an encoding method specified by the information regarding encoding included in the meta information. The 2D lossy decoding unit 254 supplies the background signal data to the 2D-3D conversion unit 255.

The 2D-3D conversion unit 255 acquires the background signal data supplied from the 2D lossy decoding unit 254. The background signal data is 2D data having a two-dimensional structure. The 2D-3D conversion unit 255 performs 2D-3D conversion on the acquired background signal data of 2D data. The background signal data subjected to the 2D-3D conversion is 3D data having a three-dimensional structure. The 2D-3D conversion unit 255 supplies the background signal data of 3D data to the combining unit 256. A method for the 2D-3D conversion is arbitrary. For example, inverse conversion of the 3D-2D conversion as described with reference to FIG. 2 may be used.

The combining unit 256 acquires the main signal data supplied from the 2D-3D conversion unit 253. Furthermore, the combining unit 256 acquires the background signal data supplied from the 2D-3D conversion unit 255. Moreover, in a case where information regarding data sorting is supplied from the separation unit 251, the combining unit 256 may acquire the information regarding the data sorting. The combining unit 256 combines the acquired main signal data and background signal data to generate (restore) the 3D data in the orthogonal coordinate system. The method for combining the main signal data and the background signal data is arbitrary. For example, the combining unit 256 may combine the main signal data and the background signal data by using a predetermined threshold value for the 3D data having a three-dimensional structure and detected in the real space. Furthermore, the combining unit 256 may combine the main signal data and the background signal data on the basis of the information regarding data sorting (for example, a threshold value or the like) supplied from the separation unit 251. The combining unit 256 supplies the generated 3D data to the coordinate system conversion unit 257.

The coordinate system conversion unit 257 acquires the 3D data in the orthogonal coordinate system supplied from the combining unit 256. Furthermore, in a case where the information regarding the coordinate system conversion is supplied from the separation unit 251, the coordinate system conversion unit 257 may acquire the information regarding the coordinate system conversion. The coordinate system conversion unit 257 converts the coordinate system of the acquired 3D data from the orthogonal coordinate system to the polar coordinate system. That is, the coordinate system conversion unit 257 generates (restores) the 3D data in the polar coordinate system (3D data having a three-dimensional structure and detected in the real space by, for example, the LiDAR sensor of the dToF method, or the like). A method for the coordinate system conversion is arbitrary. For example, the coordinate system of the 3D data may be converted from the orthogonal coordinate system to the polar coordinate system on the basis of the information from the separation unit 251 regarding the coordinate system conversion. The coordinate system conversion unit 257 outputs the generated 3D data in the polar coordinate system to outside of the decoding apparatus 250.

That is, the decoding unit 271 decodes the coded data of each of the main signal data and the background signal data that are obtained by sorting, on the basis of the signal intensity, the 3D data having a three-dimensional structure and detected in the real space, to generate main signal data and background signal data. The 2D-3D conversion unit 272 converts each of the main signal data and the background signal data from 2D data to 3D data. For example, the decoding unit 271 decodes, with a 2D decoding method, the coded data of each of the main signal data and the background signal data that are supplied from the separation unit 251, to generate the main signal data and background signal data of 2D data. The decoding unit 271 supplies the generated main signal data and background signal data of 2D data to the 2D-3D conversion unit 272. Furthermore, the 2D-3D conversion unit 272 converts the main signal data and background signal data of 2D data supplied from the decoding unit 271 to 3D data. The 2D-3D conversion unit 272 supplies the converted main signal data and background signal data of 3D data to the combining unit 256.

With the above configuration, the decoding apparatus 250 can scalably decode the coded data of 3D data having a three-dimensional structure and detected in the real space.

### <Flow of Decoding Processing>

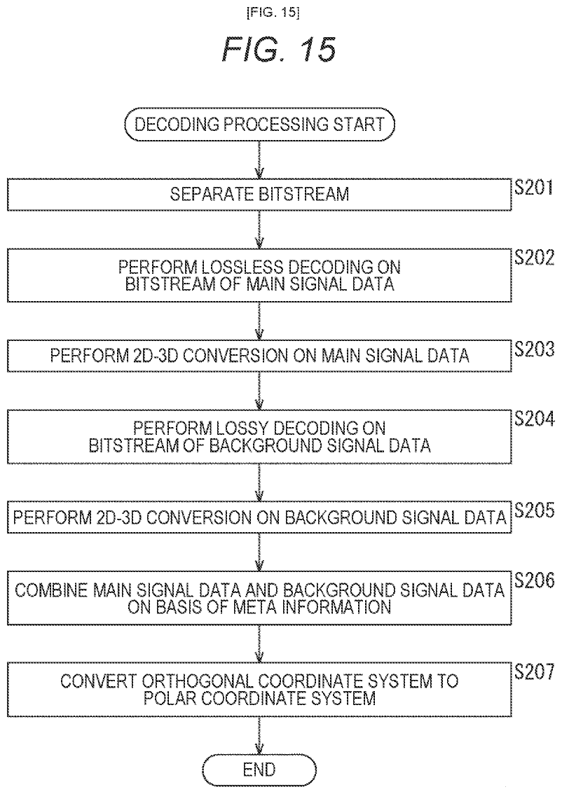

An example of a flow of decoding processing executed by the decoding apparatus 250 will be described with reference to the flowchart in FIG. 15.

When the decoding processing is started, in Step S201, the separation unit 251 of the decoding apparatus 250 separates the bitstream into the coded data of the main signal data, the coded data of the background signal data, and the meta information.

In Step S202, the 2D lossless decoding unit 252 performs, with a lossless method, 2D decoding on the coded data (bitstream) of the main signal data obtained in the processing in Step S201 to generate (restore) the main signal data of 2D data.

In Step S203, the 2D-3D conversion unit 253 performs 2D-3D conversion on the main signal data of 2D data generated in the processing in Step S202 to generate (restore) the main signal data of 3D data.

In Step S204, the 2D lossy decoding unit 254 performs, with a lossy method, 2D decoding on the coded data of the background signal data obtained in the processing in Step S201 to generate (restore) the background signal data of 2D data.

In Step S205, the 2D-3D conversion unit 255 performs 2D-3D conversion on the background signal data of 2D data generated in the processing in Step S204 to generate (restore) the background signal data of 3D data.

In Step S206, the combining unit 256 combines, on the basis of the meta information obtained in the processing in Step S201, the main signal data of 3D data generated in the processing in Step S203 and the background signal data of 3D data generated in the processing in Step S205 to generate (restore) the 3D data in the orthogonal coordinate system. For example, the combining unit 256 combines the main signal data and the background signal data on the basis of the information regarding data sorting included in the meta information.

In Step S207, on the basis of the meta information obtained in the processing in Step S201, the coordinate system conversion unit 257 converts the coordinate system of the 3D data generated in the processing in Step S206 from the orthogonal coordinate system to the polar coordinate system. For example, the coordinate system conversion unit 257 converts the coordinate system of the 3D data on the basis of the information regarding the coordinate system conversion included in the meta information.

When the processing in Step S207 ends, the decoding processing ends.

By executing each processing as described above, the decoding apparatus 250 can scalably decode the coded data of 3D data having a three-dimensional structure and detected in the real space.

### 4. Second Embodiment

### <Sorting by Function Model>

For example, as illustrated in the seventh row from the top of the table in FIG. 6, a function model approximate to 3D data may be treated as main signal data, and a difference value between the 3D data and the function model may be treated as background signal data (Method 1-3).

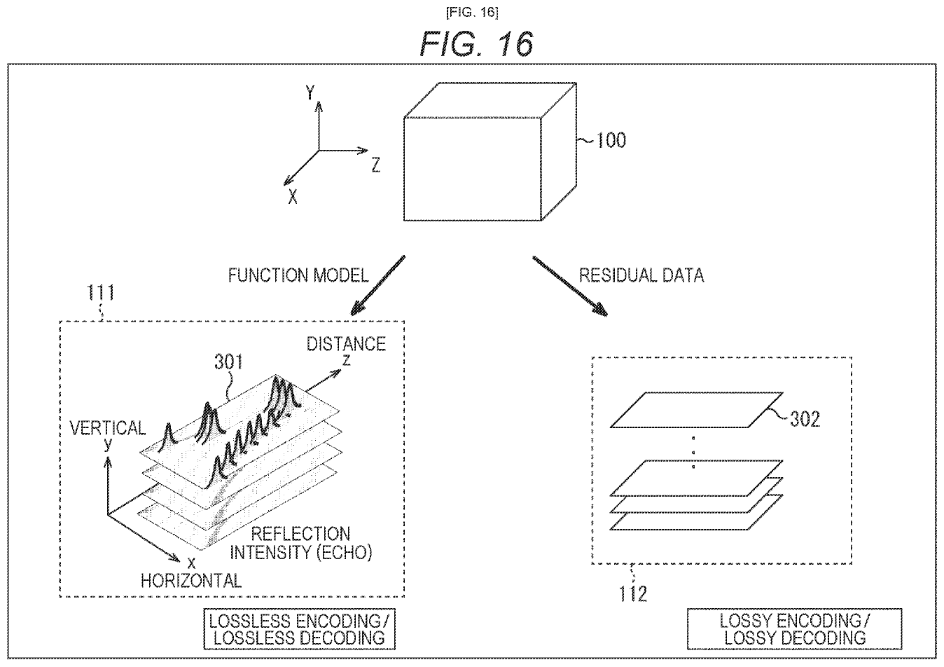

For example, as illustrated in FIG. 16, a function model 301 approximate to 3D data 100 may be generated, and the function model 301 may be sorted into main signal data 111. That is, for example, information representing the function model 301, such as information specifying a function applied to the function model 301, or a parameter used in the function is generated, and the information is sorted into the main signal data. Then, a difference value between the 3D data 100 and the function model 301 (residual data 302) may be sorted into the background signal data 112. Furthermore, the coded data of the main signal data 111 may be decoded to generate the function model 301 of 3D data, and the coded data of the background signal data 112 may be decoded to generate the difference value between the 3D data and the function model (residual data 302), and an image corresponding to the function model 301 and the difference value (residual data 302) may be combined to generate (reconstruct) the 3D data 100. Thus, a decrease in encoding efficiency can be reduced by using a function model.

The function applied to the function model is arbitrary. For example, a normal distribution may be applied as the function model. For example, as illustrated in FIG. 16, distribution of the reflection intensity can be functionally modeled by representing (approximating) the distribution of the reflection intensity with a combination of normal distributions. The normal distribution can be defined by, for example, a parameter such as a peak, an average value, or a variance. By encoding the 3D data not as an image or the like but as such a parameter of a function, a compression rate can be improved.

Of course, the function model may be other than a normal distribution. For example, a peak position of the normal distribution may be shifted according to a characteristics of a sensor. By applying a function having a waveform corresponding to the characteristic of the sensor, the encoding efficiency can be further improved.

For example, a function in which a waveform has a three-dimensional structure may be applied to the function model. A function model to which such a function is applied is also referred to as a three-dimensional function model. Furthermore, a function in which a waveform has a two-dimensional structure may be applied. A function model to which such a function is applied is also referred to as a two-dimensional function model. For example, 3D-2D conversion may be performed on the 3D data to a plurality of pieces of 2D data to generate two-dimensional function models approximate to the respective pieces of the 2D data. Moreover, a function in which a waveform has a one-dimensional structure may be applied. A function model to which such a function is applied is also referred to as a one-dimensional function model. For example, the respective pieces of 2D data obtained by performing 3D-2D conversion on the 3D data may be further converted to a plurality of pieces of one-dimensional data (for example, 2D data (or 3D data) may be scanned with a predetermined method to be converted to the one-dimensional data) to generate one-dimensional function models approximate to the respective pieces of the one-dimensional data.

It is difficult to completely represent 3D data with such a function model. Therefore, as described above, a difference between the 3D data and the function model is derived, the function model is set as the main signal data, and the difference (residual data) is set as the background signal data. With this arrangement, it is possible to represent the 3D data by combining the main signal data and the background signal data. Furthermore, scalable decoding can be easily achieved.

### <Encoding Apparatus>

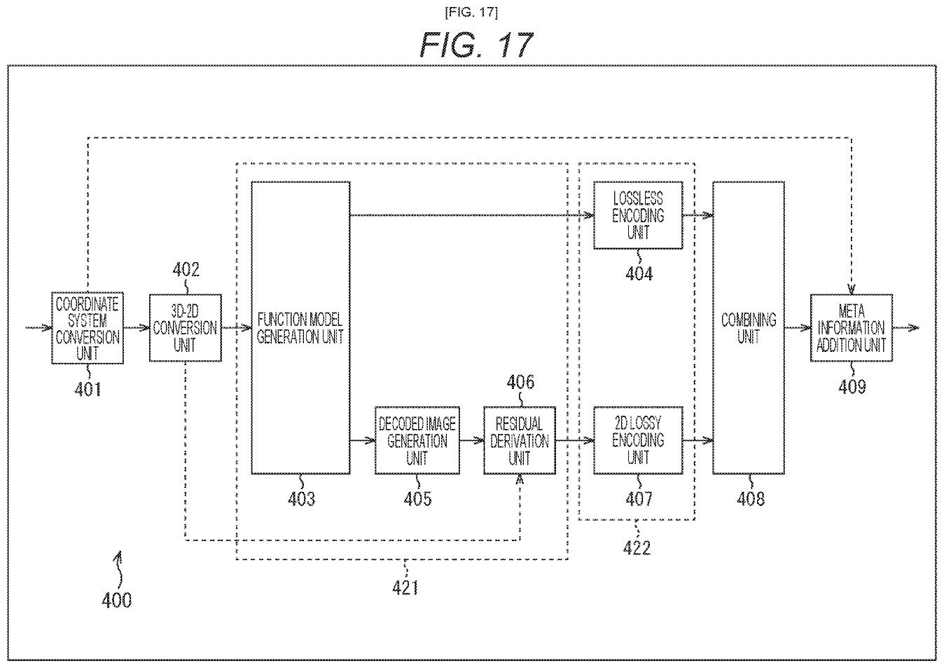

FIG. 17 is a block diagram of this case, the block diagram illustrating an example of a configuration of an encoding apparatus that is an embodiment of an image processing apparatus to which the present technology is applied. An encoding apparatus 400 illustrated in FIG. 17 is an apparatus that encodes 3D data having a three-dimensional structure and detected in a real space, such as the LiDAR data described above. For example, the encoding apparatus 400 can encode 3D data by applying the present technology described in the present embodiment.

Note that, in FIG. 17, main parts of processing units, data flows, and the like are illustrated, and those illustrated in FIG. 17 are not necessarily all. That is, in the encoding apparatus 400, there may be a processing unit not illustrated as a block in FIG. 17, or there may be a flow of processing or data not illustrated as an arrow or the like in FIG. 17.

As illustrated in FIG. 17, the encoding apparatus 400 includes a coordinate system conversion unit 401, a 3D-2D conversion unit 402, a function model generation unit 403, a lossless encoding unit 404, a decoded image generation unit 405, a residual derivation unit 406, a 2D lossy encoding unit 407, a combining unit 408, and a meta information addition unit 409. The function model generation unit 403, the decoded image generation unit 405, and the residual derivation unit 406 may be regarded as a data sorting unit 421 in the present disclosure. Furthermore, the lossless encoding unit 404 and the 2D lossy encoding unit 407 may be regarded as an encoding unit 422 in the present disclosure.

The coordinate system conversion unit 401 acquires 3D data in a polar coordinate system input to the encoding apparatus 400. This 3D data is 3D data having a three-dimensional structure and detected in a real space by, for example, a LiDAR sensor of a dToF method, or the like. The coordinate system conversion unit 401 converts a coordinate system of the 3D data from the polar coordinate system to an orthogonal coordinate system. The coordinate system conversion unit 401 supplies the generated 3D data in an orthogonal coordinate system to the 3D-2D conversion unit 402. Furthermore, the coordinate system conversion unit 401 may supply the meta information addition unit 409 with information regarding the conversion of the coordinate system. Note that, in a case where the coordinate system of the 3D data input to the encoding apparatus 400 is an orthogonal coordinate system, this processing is omitted.

The 3D-2D conversion unit 402 acquires the 3D data in the orthogonal coordinate system supplied from the coordinate system conversion unit 401. The 3D-2D conversion unit 402 performs 3D-2D conversion on the acquired 3D data to generate (a plurality of pieces of) 2D data. The 3D-2D conversion unit 402 supplies the function model generation unit 403 with the generated 2D data (obtained by performing 3D-2D conversion on the 3D data having a three-dimensional structure and detected in the real space). A method for the 3D-2D conversion is arbitrary. For example, the conversion may be performed by a method described with reference to FIG. 2. Furthermore, the 3D-2D conversion unit 402 supplies the 2D data also to the residual derivation unit 406.

The function model generation unit 403 acquires the 2D data (obtained by converting the 3D data having a three-dimensional structure and detected in the real space) supplied from the 3D-2D conversion unit 402. By using a predetermined function, the function model generation unit 403 generates a function model approximate to each of the acquired 2D data. The function model generation unit 403 sorts out the generated function model (that is, information indicating a function that constitutes the function model, a parameter of the function, and the like) as the main signal data and supplies the main signal data to the lossless encoding unit 404. Furthermore, the function model generation unit 403 supplies the function model also to the decoded image generation unit 405.

The lossless encoding unit 404 acquires the function model (that is, information indicating a function that constitutes the function model, a parameter of the function, and the like) supplied from the function model generation unit 403 as the main signal data. The lossless encoding unit 404 encodes the acquired main signal data (function model) with a lossless encoding method to generate coded data of the main signal data (function model). The encoding method of this encoding may be any encoding method as long as the encoding method is a lossless encoding method. The lossless encoding unit 404 supplies the coded data of the generated function model (coded data of the main signal data) to the combining unit 408.

The decoded image generation unit 405 acquires the function model (that is, information indicating a function that constitutes the function model, a parameter of the function, and the like) supplied from the function model generation unit 403. By using the acquired function model, the decoded image generation unit 405 generates 2D data (decoded image) equivalent to the function model. The decoded image generation unit 405 plots the function model to generate a decoded image. That is, there is generated a decoded image corresponding to each of 2D data obtained by performing 3D-2D conversion on the 3D data having a three-dimensional structure and detected in the real space (an image obtained by plotting, on a plane of each of the 2D data, a function model corresponding to the plane). The decoded image generation unit 405 supplies the generated decoded image to the residual derivation unit 406.

The residual derivation unit 406 acquires the 2D data (obtained by converting the 3D data having a three-dimensional structure and detected in the real space) supplied from the 3D-2D conversion unit 402. Furthermore, the residual derivation unit 406 acquires the decoded image (2D data obtained by plotting the function model) supplied from the decoded image generation unit 405. The residual derivation unit 406 derives residual data (residual image) that is a difference between the acquired 2D data and the decoded image. A method for deriving a residual is arbitrary. The residual derivation unit 406 supplies the derived residual data to the 2D lossy encoding unit 407 as background signal data.

The 2D lossy encoding unit 407 acquires the residual data supplied from the residual derivation unit 406 as the background signal data. The 2D lossy encoding unit 407 performs 2D encoding on the acquired background signal data (residual data) with a lossy method to generate coded data of the background signal data (residual data). The encoding method of this 2D encoding may be any encoding method as long as the encoding method is a lossy encoding method and is a 2D encoding method. The 2D lossy encoding unit 407 supplies the coded data of the generated residual data (coded data of the background signal data) to the combining unit 408.

The combining unit 408 acquires the coded data of the main signal data supplied from the lossless encoding unit 404. Furthermore, the combining unit 408 acquires the coded data of the background signal data supplied from the 2D lossy encoding unit 407. The combining unit 408 combines the acquired coded data of the main signal data and the coded data of the background signal data to generate one piece of coded data (one bitstream). A method for combining the coded data is arbitrary. The combining unit 408 supplies the generated coded data (bitstream) to the meta information addition unit 409.

The meta information addition unit 409 acquires the coded data (bitstream) supplied from the combining unit 408. The meta information addition unit 409 adds meta information to the acquired coded data. For example, the meta information addition unit 409 may acquire information regarding coordinate system conversion supplied from the coordinate system conversion unit 401, and add the information to the coded data as the meta information. Note that content of the meta information added to the coded data is arbitrary. The meta information may include information other than information regarding the coordinate system conversion. For example, as described above in <2. Sorting based on signal intensity>, information regarding encoding may be included in the meta information. To outside of the encoding apparatus 400, the meta information addition unit 409 outputs the coded data (bitstream) to which the meta information is added. The coded data (bitstream) is transmitted to a decoding apparatus via a transmission path, a recording medium, another apparatus, or the like, for example.

That is, the data sorting unit 421 sorts out the function model of the 3D data having a three-dimensional structure and detected in the real space as the main signal data, and sorts out the difference value between the 3D data and the function model as the background signal data. The encoding unit 422 encodes each of the main signal data and background signal data that are sorted out in this manner, to generate coded data. For example, the data sorting unit 421 generates, by using a predetermined function, a function model approximate to the 2D data (obtained by converting the 3D data to be encoded) supplied from the 3D-2D conversion unit 402, and sorts out the function model as the main signal data. Furthermore, the data sorting unit 421 generates 2D data (decoded image) equivalent to the function model, derives residual data (residual image) between the 2D data (obtained by converting the 3D data to be encoded) supplied from the 3D-2D conversion unit 402 and the decoded image, and sorts out the residual data as the background signal data. Then, the data sorting unit 421 supplies the encoding unit 422 with the main signal data and background signal data sorted out as described above. The encoding unit 422 encodes each of the main signal data and background signal data supplied from the data sorting unit 421, to generate coded data. An encoding unit 522 supplies the generated coded data of each of the main signal data and the background signal data to the combining unit 408.

With the above configuration, on the basis of the signal intensity, the encoding apparatus 400 can sort the 3D data having a three-dimensional structure and detected in the real space into the main signal data and the background signal data, and encode the main signal data and the background signal data. Therefore, the decoding apparatus can scalably decode the coded data of 3D data having a three-dimensional structure and detected in the real space.

### <Flow of Encoding Processing>

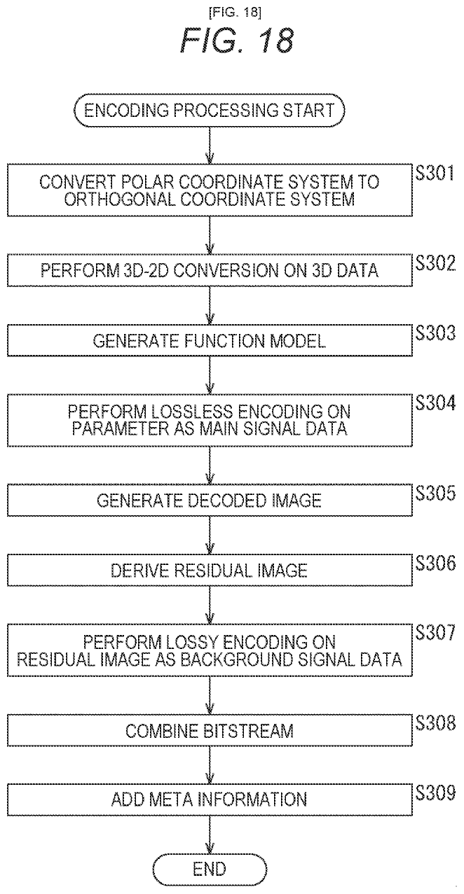

An example of a flow of encoding processing executed by the encoding apparatus 400 will be described with reference to the flowchart in FIG. 18.

When the encoding processing is started, the coordinate system conversion unit 401 in the encoding apparatus 400 converts the coordinate system of 3D data having a three-dimensional structure and detected in the real space, from the polar coordinate system to the orthogonal coordinate system in Step S301.

In Step S302, the 3D-2D conversion unit 402 performs 3D-2D conversion on the 3D data in the orthogonal coordinate system obtained in the processing in Step S301.

In Step S303, the function model generation unit 403 generates a function model approximate to the 3D data (2D data obtained in the processing in Step S302), and sorts out the function model as the main signal data.

In Step S304, the lossless encoding unit 404 encodes, with a lossless encoding method, the function model (such as a parameter representing the function) generated in the processing in Step S303 as the main signal data to generate coded data of the main signal data.

In Step S305, the decoded image generation unit 405 generates a decoded image on the basis of the function model generated in the processing in Step S303.

In Step S306, the residual derivation unit 406 derives residual data (residual image) between the 2D data generated in the processing in Step S302 and the decoded image generated in the processing in Step S305, and sorts out the residual data as the background signal data.

In Step S307, the 2D lossy encoding unit 407 performs 2D encoding with a lossy encoding method on the residual image generated in the processing in Step S306 as the background signal data, to generate coded data of the background signal data.

In Step S308, the combining unit 408 combines the coded data of the main signal data generated in the processing in Step S304 and the coded data of the background signal data generated in the processing in Step S307, to generate one bitstream (coded data of the 3D data detected in the real space).

In Step S309, the meta information addition unit 409 adds, to the bitstream generated in the processing in Step S308, meta information including, for example, information regarding the coordinate system conversion.

When the processing in Step S309 ends, the encoding processing ends.

By executing each processing as described above, on the basis of the signal intensity, the encoding apparatus 400 can sort the 3D data having a three-dimensional structure and detected in the real space into the main signal data and the background signal data, and encode the main signal data and the background signal data. Therefore, the decoding apparatus can scalably decode the coded data of 3D data having a three-dimensional structure and detected in the real space.

### <Decoding Apparatus>

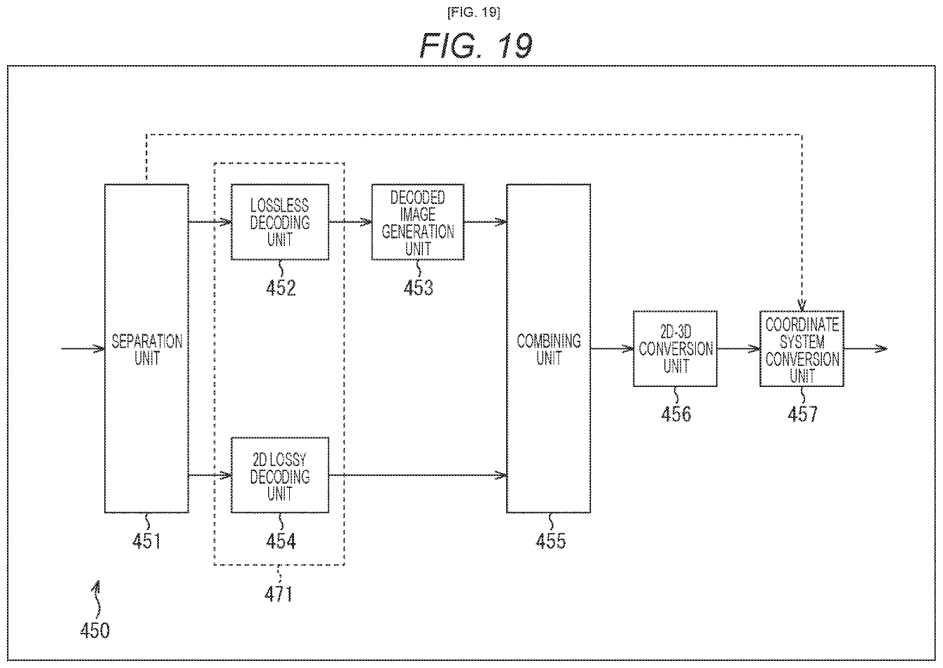

FIG. 19 is a block diagram of this case, the block diagram illustrating an example of a configuration of a decoding apparatus that is an embodiment of an image processing apparatus to which the present technology is applied. A decoding apparatus 450 illustrated in FIG. 19 is an apparatus that decodes the coded data of the 3D data generated by the above-described encoding apparatus 400 and detected in the real space. For example, the decoding apparatus 450 can decode the coded data of the 3D data by applying the present technology described in the present embodiment.

Note that, in FIG. 19, main parts of processing units, data flows, and the like are illustrated, and those illustrated in FIG. 19 are not necessarily all. That is, in the decoding apparatus 450, there may be a processing unit not illustrated as a block in FIG. 19, or there may be a flow of processing or data not illustrated as an arrow or the like in FIG. 19.

As illustrated in FIG. 19, the decoding apparatus 450 includes a separation unit 451, a lossless decoding unit 452, a decoded image generation unit 453, a 2D lossy decoding unit 454, a combining unit 455, a 2D-3D conversion unit 456, and a coordinate system conversion unit 457. The lossless decoding unit 452 and the 2D lossy decoding unit 454 may be regarded as a decoding unit 471 in the present disclosure.

The separation unit 451 acquires the coded data (bitstream) of the 3D data input to the decoding apparatus 450. The separation unit 451 parses the acquired bitstream and separates the bitstream into the coded data of the main signal data, the coded data of the background signal data, and the meta information. In other words, the separation unit 451 extracts these pieces of information from the bitstream. The separation unit 451 supplies the coded data of the extracted main signal data to the lossless decoding unit 452.

Furthermore, the separation unit 451 supplies the coded data of the extracted background signal data to the 2D lossy decoding unit 454. Moreover, in a case where the extracted meta information includes information regarding coordinate system conversion, the separation unit 451 may supply the coordinate system conversion unit 457 with the information regarding the coordinate system conversion.

The lossless decoding unit 452 acquires the coded data of the main signal data supplied from the separation unit 451. The lossless decoding unit 452 decodes, with a lossless decoding method, the acquired coded data of the main signal data, to generate (restore) the main signal data (such as a parameter indicating the function model). This decoding method of the decoding may be any decoding method as long as the decoding method is a decoding method (a lossless decoding method) corresponding to an encoding method applied to encoding of main signal data. For example, as described above in <2. Sorting based on signal intensity>, the decoding method may be a decoding method corresponding to an encoding method specified by the information regarding encoding included in the meta information. The lossless decoding unit 452 supplies the main signal data to the decoded image generation unit 453.

The decoded image generation unit 453 acquires the main signal data (function model) supplied from the lossless decoding unit 452. The decoded image generation unit 453 generates 2D data (decoded image) equivalent to the function model by using the acquired function model (that is, information indicating a function that constitutes the function model, a parameter of the function, and the like). The decoded image generation unit 453 plots the function model to generate a decoded image, similarly to a case of the decoded image generation unit 405 described above. That is, there is generated a decoded image corresponding to each of 2D data obtained by performing 3D-2D conversion on the 3D data having a three-dimensional structure and detected in the real space (an image obtained by plotting, on a plane of each of the 2D data, a function model corresponding to the plane). The decoded image generation unit 453 supplies the generated decoded image to the combining unit 455.

The 2D lossy decoding unit 454 acquires the coded data of the background signal data supplied from the separation unit 451. The 2D lossy decoding unit 454 performs, with a lossy decoding method, 2D decoding on the coded data of the acquired background signal data to generate (restore) background signal data (residual image) of 2D data. This decoding method of the 2D decoding may be any decoding method as long as the decoding method is a decoding method (a lossy decoding method, and a 2D decoding method) corresponding to an encoding method applied to encoding of background signal data. For example, as described above in <2. Sorting based on signal intensity>, the decoding method may be a decoding method corresponding to an encoding method specified by the information regarding encoding included in the meta information. The 2D lossy decoding unit 454 supplies the residual image to the combining unit 455 as the background signal data.

The combining unit 455 acquires the decoded image supplied from the decoded image generation unit 453. Furthermore, the combining unit 455 acquires the residual image supplied from the 2D lossy decoding unit 454. Moreover, the combining unit 455 combines the acquired decoded image and residual image to generate (restore) 2D data. The combining unit 455 supplies the generated 2D data to the 2D-3D conversion unit 456.

The 2D-3D conversion unit 456 acquires the 2D data supplied from the combining unit 455. The 2D-3D conversion unit 456 performs 2D-3D conversion on the acquired 2D data to generate (restore) 3D data in the orthogonal coordinate system. The 2D-3D conversion unit 456 supplies the generated 3D data in the orthogonal coordinate system to the coordinate system conversion unit 457.

The coordinate system conversion unit 457 acquires the 3D data in the orthogonal coordinate system supplied from the 2D-3D conversion unit 456. Furthermore, in a case where the information regarding the coordinate system conversion is supplied from the separation unit 451, the coordinate system conversion unit 257 may acquire the information regarding the coordinate system conversion. The coordinate system conversion unit 457 converts the coordinate system of the acquired 3D data from the orthogonal coordinate system to data in the polar coordinate system. That is, the coordinate system conversion unit 457 generates (restores) the 3D data in the polar coordinate system (3D data having a three-dimensional structure and detected in the real space by, for example, the LiDAR sensor of the dToF method, or the like). A method for the coordinate system conversion is arbitrary. For example, the coordinate system of the 3D data may be converted from the orthogonal coordinate system to the polar coordinate system on the basis of the information from the separation unit 451 regarding the coordinate system conversion. The coordinate system conversion unit 457 outputs the generated 3D data in the polar coordinate system to outside of the decoding apparatus 450.

That is, the decoding unit 471 decodes the coded data of each of the main signal data and the background signal data that are obtained by sorting, on the basis of the signal intensity, the 3D data having a three-dimensional structure and detected in the real space, to generate main signal data and background signal data.

For example, the decoding unit 471 decodes each of the coded data of the main signal data and the coded data of the background signal data that are supplied from the separation unit 451, to generate the main signal data and the background signal data. The main signal data includes, for example, a parameter indicating a function model approximate to 2D data obtained by performing 3D-2D conversion on 3D data having a three-dimensional structure and detected in the real space. Furthermore, the background signal data includes residual data (residual image) between the 2D data obtained by performing the 3D-2D conversion on the 3D data having a three-dimensional structure and detected in the real space, and the 2D data equivalent to the function model. The decoding unit 471 supplies the generated main signal data to the decoded image generation unit 453.

Furthermore, the decoding unit 471 supplies the generated background signal data to the combining unit 455.

With the above configuration, the decoding apparatus 450 can scalably decode the coded data of 3D data having a three-dimensional structure and detected in the real space.

### <Flow of Decoding Processing>

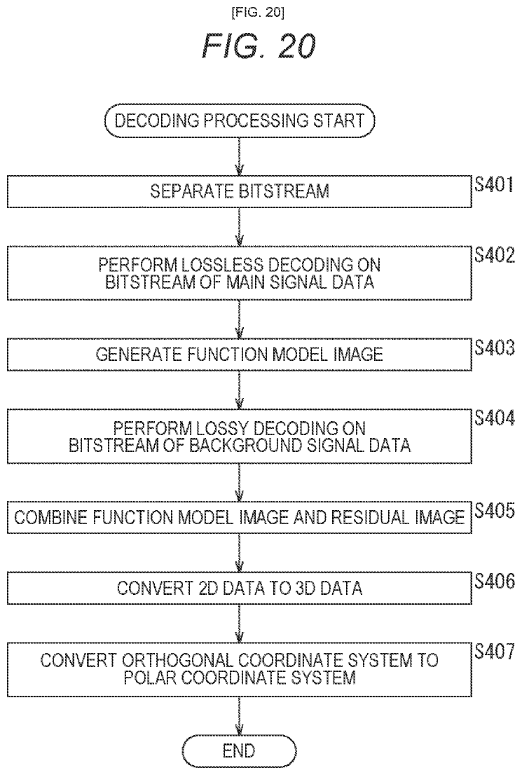

An example of a flow of decoding processing executed by the decoding apparatus 450 will be described with reference to the flowchart in FIG. 20.

When the decoding processing is started, in Step S401, the separation unit 451 of the decoding apparatus 450 separates the bitstream into the coded data of the main signal data (function model), the coded data of the background signal data (residual image), and the meta information.

In Step S402, the lossless decoding unit 452 decodes, with a lossless decoding method, the coded data (bitstream) of the main signal data obtained in the processing in Step S401 to generate (restore) the main signal data (that is, information indicating a function that constitutes a function model, a parameter of the function, and the like).

In Step S403, the decoded image generation unit 453 generates 2D data (decoded image) equivalent to the function model generated in the processing in Step S402. In Step S404, the 2D lossy decoding unit 454 performs, with a lossy decoding method, 2D decoding on the coded data of the background signal data obtained in the processing in Step S401 to generate (restore) background signal data (residual image) of 2D data.

In Step S405, the combining unit 455 combines the decoded image generated in the processing in Step S403 and the residual image generated in the processing in Step S404, to generate (restore) 2D data.

In Step S406, the 2D-3D conversion unit 456 performs 2D-3D conversion on the 2D data generated in the processing in Step S405 to generate (restore) 3D data in the orthogonal coordinate system.

In Step S407, on the basis of the meta information obtained in the processing in Step S401, the coordinate system conversion unit 457 converts the coordinate system of the 3D data generated in the processing in Step S406 from the orthogonal coordinate system to the polar coordinate system. For example, the coordinate system conversion unit 457 converts the coordinate system of the 3D data on the basis of the information regarding the coordinate system conversion included in the meta information.

When the processing in Step S407 ends, the decoding processing ends.

By executing each processing as described above, the decoding apparatus 450 can scalably decode the coded data of 3D data having a three-dimensional structure and detected in the real space.

### 5. Third Embodiment

### <Sorting by Threshold Value and Function Model>

Method 1-2 and Method 1-3 described above may be applied in combination. For example, as illustrated in the bottom row of the table in FIG. 6, the main signal data sorted out by a threshold value for the signal intensity may be approximated by the function model (Method 1-4). That is, the 3D data may be sorted into the main signal data and the background signal data by using the threshold value for the signal intensity, and the main signal data may be further sorted into the function model and the residual data.

For example, the 3D data having signal intensity greater than a predetermined threshold value may be sorted out as the main signal data, and the 3D data having signal intensity equal to or smaller than the predetermined threshold value may be sorted out as the background signal data, and the main signal data may be sorted into a function model of the main signal data and a difference value between the main signal data and the function model. Furthermore, each of coded data of the function model of the main signal data, coded data of the difference value between the main signal data and the function model, and coded data of the background signal data may be decoded, an image of the function model and the difference value may be combined to generate the main signal data, and the main signal data and the background signal data may be combined to generate the 3D data.

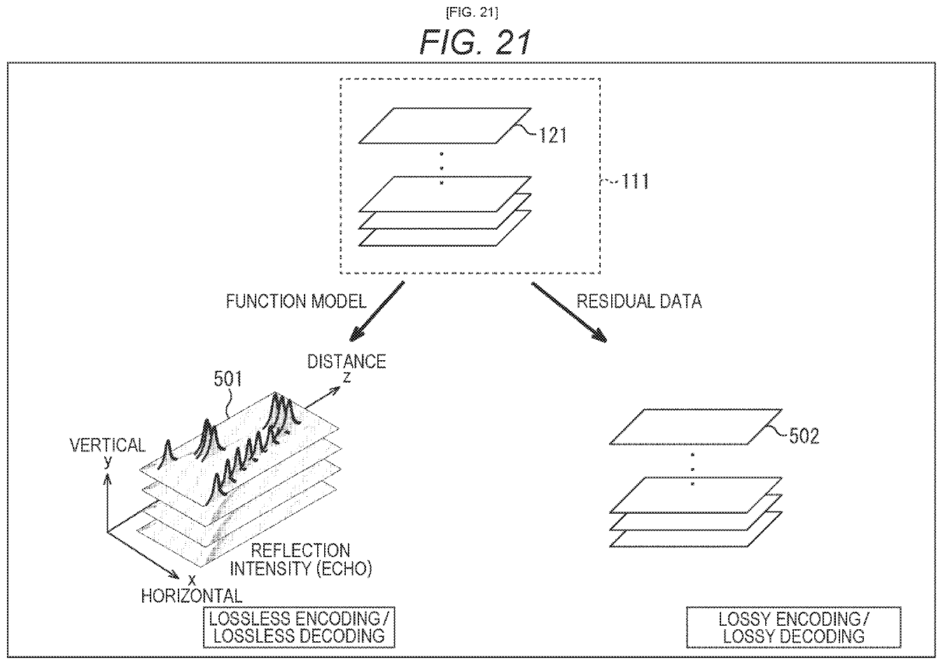

For example, as illustrated in FIG. 21, a function model 501 approximate to the main signal data 111 may be generated, and a difference (residual data 502) between the main signal data 111 and the function model 501 may be generated. The function model and the residual data are similar to the function model and the residual data of the second embodiment (Method 1-3) except that target data is not 3D data detected in the real space but main signal data. That is, as long as there is no contradiction, for example, description of the function model and residual data described above in <Sorting by function model> and the like can be applied.

Thus, by sorting the main signal data 111 into the function model 501 and a difference (residual data 502), and encoding each of the function model 501 and the difference, the main signal data can be scalably decoded. Therefore, scalability of decoding can be improved.

### <Encoding Apparatus>

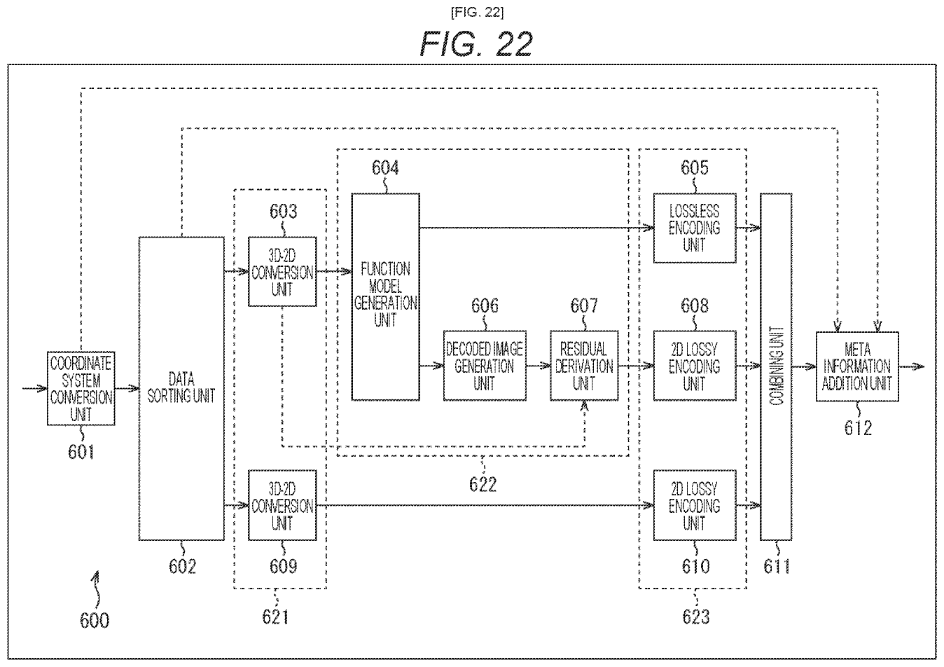

FIG. 22 is a block diagram of this case, the block diagram illustrating an example of a configuration of an encoding apparatus that is an embodiment of an image processing apparatus to which the present technology is applied. An encoding apparatus 600 illustrated in FIG. 22 is an apparatus that encodes 3D data having a three-dimensional structure and detected in a real space, such as the LiDAR data described above. For example, the encoding apparatus 600 can encode 3D data by applying the present technology described in the present embodiment.

Note that, in FIG. 22, main parts of processing units, data flows, and the like are illustrated, and those illustrated in FIG. 22 are not necessarily all. That is, in the encoding apparatus 600, there may be a processing unit not illustrated as a block in FIG. 22, or there may be a flow of processing or data not illustrated as an arrow or the like in FIG. 22.

As illustrated in FIG. 22, the encoding apparatus 600 includes a coordinate system conversion unit 601, a data sorting unit 602, a 3D-2D conversion unit 603, a function model generation unit 604, a lossless encoding unit 605, a decoded image generation unit 606, a residual derivation unit 607, a 2D lossy encoding unit 608, a 3D-2D conversion unit 609, a 2D lossy encoding unit 610, a combining unit 611, and a meta information addition unit 612. The 3D-2D conversion unit 603 and the 3D-2D conversion unit 609 may be regarded as a 3D-2D conversion unit 621 in the present disclosure. Furthermore, the function model generation unit 604, the decoded image generation unit 606, and the residual derivation unit 607 may be regarded as a data sorting unit 622 in the present disclosure. Moreover, the lossless encoding unit 605, the 2D lossy encoding unit 608, and the 2D lossy encoding unit 610 may be regarded as an encoding unit 623 in the present disclosure.

The coordinate system conversion unit 601 acquires 3D data in a polar coordinate system input to the encoding apparatus 600. This 3D data is 3D data having a three-dimensional structure and detected in a real space by, for example, a LiDAR sensor of a dToF method, or the like. The coordinate system conversion unit 601 converts a coordinate system of the 3D data from the polar coordinate system to an orthogonal coordinate system. The coordinate system conversion unit 601 supplies the generated 3D data in the orthogonal coordinate system to the data sorting unit 602. Furthermore, the coordinate system conversion unit 601 may supply the meta information addition unit 612 with information regarding the conversion of the coordinate system. Note that, in a case where the coordinate system of the 3D data input to the encoding apparatus 600 is an orthogonal coordinate system, this processing is omitted.

The data sorting unit 602 acquires the 3D data in the orthogonal coordinate system supplied from the coordinate system conversion unit 601. The data sorting unit 602 sorts the acquired 3D data into the main signal data and the background signal data. Note that a method for this sorting is arbitrary. For example, the data sorting unit 602 may sort the 3D data into the main signal data and the background signal data by using a threshold value for the signal intensity. In this case, for example, the data sorting unit 602 may sort out the 3D data having signal intensity greater than a predetermined threshold value as main signal data, and may sort out the 3D data having signal intensity equal to or smaller than the threshold value as background signal data. The data sorting unit 602 supplies the sorted out main signal data to the 3D-2D conversion unit 603. Furthermore, the data sorting unit 602 supplies the sorted out background signal data to the 3D-2D conversion unit 609. Moreover, the data sorting unit 602 may supply the meta information addition unit 612 with information regarding data sorting (for example, a threshold value or the like). Note that the threshold value applied by the data sorting unit 602 may be any value.

The 3D-2D conversion unit 603 acquires the main signal data supplied from the data sorting unit 602. The main signal data is 3D data having a three-dimensional structure. The 3D-2D conversion unit 603 performs 3D-2D conversion on the acquired main signal data of 3D data. The main signal data subjected to the 3D-2D conversion is 2D data having a two-dimensional structure. The 3D-2D conversion unit 603 supplies the main signal data of 2D data to the function model generation unit 604. A method for the 3D-2D conversion is arbitrary. For example, the conversion may be performed by a method described with reference to FIG. 2. Furthermore, the 3D-2D conversion unit 603 supplies the main signal data of 2D data also to the residual derivation unit 607.

The function model generation unit 604 acquires the main signal data supplied from the 3D-2D conversion unit 603. By using a predetermined function, the function model generation unit 604 generates a function model approximate to the acquired main signal data. The function model generation unit 604 supplies the lossless encoding unit 605 with the generated function model (that is, information indicating a function that constitutes the function model, a parameter of the function, and the like). Furthermore, the function model generation unit 604 supplies the function model also to the decoded image generation unit 606.

The lossless encoding unit 605 acquires the function model (that is, information indicating a function that constitutes the function model, a parameter of the function, and the like) supplied from the function model generation unit 604. The lossless encoding unit 605 encodes the acquired function model with a lossless encoding method to generate coded data of the function model. The encoding method of this encoding may be any encoding method as long as the encoding method is a lossless encoding method. The lossless encoding unit 605 supplies the coded data of the generated function model to the combining unit 611.

The decoded image generation unit 606 acquires the function model (that is, information indicating a function that constitutes the function model, a parameter of the function, and the like) supplied from the function model generation unit 604. By using the acquired function model, the decoded image generation unit 606 generates 2D data (decoded image) equivalent to the function model. The decoded image generation unit 606 plots the function model to generate a decoded image. That is, there is generated a decoded image corresponding to the main signal data of 2D data (an image obtained by plotting, on a plane of the main signal data, a function model corresponding to the plane). The decoded image generation unit 606 supplies the generated decoded image to the residual derivation unit 607.

The residual derivation unit 607 acquires main signal data of 2D data supplied from the 3D-2D conversion unit 603. Furthermore, the residual derivation unit 607 acquires the decoded image (2D data obtained by plotting the function model) supplied from the decoded image generation unit 606. The residual derivation unit 607 derives residual data (residual image) that is a difference between the acquired main signal data and the decoded image. A method for deriving a residual is arbitrary. The residual derivation unit 607 supplies the derived residual data to the 2D lossy encoding unit 608.

The 2D lossy encoding unit 608 acquires the residual data supplied from the residual derivation unit 607. The 2D lossy encoding unit 608 performs 2D encoding on the acquired residual data with a lossy encoding method, to generate coded data of the residual data. The encoding method of this 2D encoding may be any encoding method as long as the encoding method is a lossy encoding method and is a 2D encoding method. The 2D lossy encoding unit 608 supplies the coded data of the generated residual data to the combining unit 611.

The 3D-2D conversion unit 609 acquires the background signal data supplied from the data sorting unit 602. The background signal data is 3D data having a three-dimensional structure. The 3D-2D conversion unit 609 performs 3D-2D conversion on the acquired background signal data of 3D data. The background signal data subjected to the 3D-2D conversion is 2D data having a two-dimensional structure. The 3D-2D conversion unit 609 supplies the background signal data of 2D data to the 2D lossy encoding unit 610. A method for the 3D-2D conversion is arbitrary. For example, the conversion may be performed by a method described with reference to FIG. 2.

The 2D lossy encoding unit 610 acquires the background signal data supplied from the 3D-2D conversion unit 609. The background signal data is 2D data having a two-dimensional structure. The 2D lossy encoding unit 610 performs, with a lossy encoding method, 2D encoding on the background signal data to generate coded data. The encoding method of this 2D encoding may be any encoding method as long as the encoding method is a lossy encoding method and is a 2D encoding method. The 2D lossy encoding unit 610 supplies coded data of the generated background signal data to the combining unit 611.

The combining unit 611 acquires the coded data of the function model supplied from the lossless encoding unit 605. Furthermore, the combining unit 611 acquires the coded data of the residual data supplied from the 2D lossy encoding unit 608. Moreover, the combining unit 611 acquires the coded data of the background signal data supplied from the 2D lossy encoding unit 610. The combining unit 611 combines those acquired coded data to generate one piece of coded data (one bitstream). A method for combining the coded data is arbitrary. The combining unit 611 supplies the generated coded data (bitstream) to the meta information addition unit 612.

The meta information addition unit 612 acquires the coded data (bitstream) supplied from the combining unit 611. The meta information addition unit 612 adds meta information to the acquired coded data. For example, the meta information addition unit 612 may acquire information regarding coordinate system conversion supplied from the coordinate system conversion unit 601, and add the information to the coded data as the meta information. Furthermore, the meta information addition unit 612 may acquire information regarding data sorting supplied from the data sorting unit 602, and add the information to the coded data as the meta information. Note that content of the meta information added to the coded data is arbitrary. The meta information may include information other than information other than these examples. For example, as described above in <2. Sorting based on signal intensity>, information regarding encoding may be included in the meta information. To outside of the encoding apparatus 600, the meta information addition unit 612 outputs the coded data (bitstream) to which the meta information is added. The coded data (bitstream) is transmitted to a decoding apparatus via a transmission path, a recording medium, another apparatus, or the like, for example.

That is, the 3D-2D conversion unit 621 converts, to 2D data, each of the main signal data and the background signal data that are obtained by sorting, on the basis of the signal intensity, the 3D data having a three-dimensional structure and detected in the real space. The data sorting unit 622 sorts the main signal data into the function model and residual data. The encoding unit 623 encodes each of the function model and residual data of the main signal data and the background signal data to generate coded data. For example, the 3D-2D conversion unit 621 converts each of the main signal data and background signal data of 3D data supplied from the data sorting unit 602 to 2D data, supplies the main signal data to the data sorting unit 622, and supplies the background signal data to the encoding unit 623. Furthermore, the data sorting unit 622 sorts, by using a predetermined function, the main signal data supplied from the 3D-2D conversion unit 621 to the function model and the residual data, and supplies each of the function model and the residual data to the encoding unit 623. The encoding unit 623 encodes each of the function model and residual data of the main signal data supplied from the data sorting unit 622, and the background signal data supplied from the 3D-2D conversion unit 621, to generate coded data. The encoding unit 623 supplies each of the generated coded data to the combining unit 611.

With the above configuration, on the basis of the signal intensity, the encoding apparatus 600 can sort the 3D data having a three-dimensional structure and detected in the real space into a plurality of pieces of data, and encode the plurality of pieces of data. Therefore, the decoding apparatus can scalably decode the coded data of 3D data having a three-dimensional structure and detected in the real space.

### <Flow of Encoding Processing>

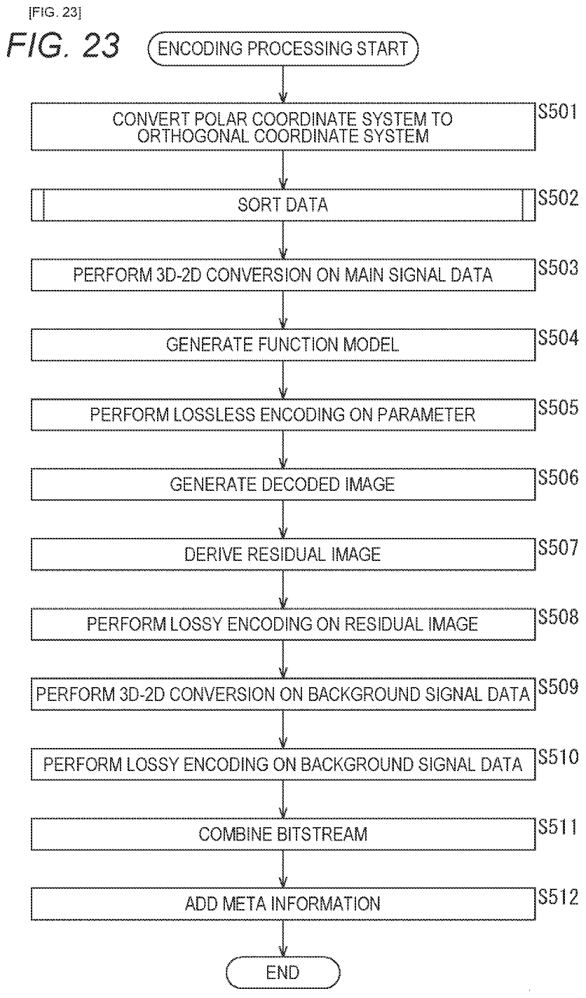

An example of a flow of encoding processing executed by the encoding apparatus 600 will be described with reference to the flowchart in FIG. 23.

When the encoding processing is started, the coordinate system conversion unit 601 in the encoding apparatus 600 converts the coordinate system of 3D data from the polar coordinate system to the orthogonal coordinate system in Step S501.

In Step S502, the data sorting unit 602 executes sorting processing to sort the 3D data in the orthogonal coordinate system obtained in the processing in Step S501 into the main signal data and the background signal data. This sorting processing is performed in a flow similar to the case described with reference to the flowchart in FIG. 13. That is, the description of the sorting processing with reference to the flowchart in FIG. 13 can be applied as description of this sorting processing.

In Step S503, the 3D-2D conversion unit 603 performs 3D-2D conversion on the main signal data of 3D data sorted out in the processing in Step S502.

In Step S504, the function model generation unit 604 generates a function model approximate to the main signal data of 2D data obtained in the processing in Step S503.

In Step S505, the lossless encoding unit 605 encodes, with a lossless encoding method, the function model (such as a parameter representing the function) generated in the processing in Step S504, to generate coded data of the function model.

In Step S506, the decoded image generation unit 606 generates a decoded image on the basis of the function model generated in the processing in Step S504.

In Step S507, the residual derivation unit 607 derives residual data (residual image) between the main signal data of 2D data generated in the processing in Step S503 and the decoded image generated in the processing in Step S506.

In Step S508, the 2D lossy encoding unit 608 performs 2D encoding with a lossy encoding method on the residual data (residual image) generated in the processing in Step S507, to generate coded data of the residual data.

In Step S509, the 3D-2D conversion unit 609 performs 3D-2D conversion on the background signal data of 3D data sorted out in the processing in Step S502.

In Step S510, the 2D lossy encoding unit 206 performs 2D encoding, with a lossy encoding method, on the background signal data of 2D data obtained in the processing in Step S509, to generate coded data of the background signal data.

In Step S511, the combining unit 611 combines the coded data of the function model generated in the processing in Step S505, the coded data of the residual image generated in the processing in Step S508, and the coded data of the background signal data generated in the processing in Step S510, to generate one bitstream (coded data of 3D data).

In Step S512, the meta information addition unit 612 adds meta information including information regarding coordinate system conversion for example, or information regarding data sorting, such as a threshold value for example, to the bitstream generated in the processing in Step S511.

When the processing in Step S512 ends, the encoding processing ends.

By executing each processing as described above, on the basis of the signal intensity, the encoding apparatus 600 can sort the 3D data having a three-dimensional structure and detected in the real space into the main signal data and the background signal data, and encode the main signal data and the background signal data. Therefore, the decoding apparatus can scalably decode the coded data of 3D data having a three-dimensional structure and detected in the real space.

### <Decoding Apparatus>

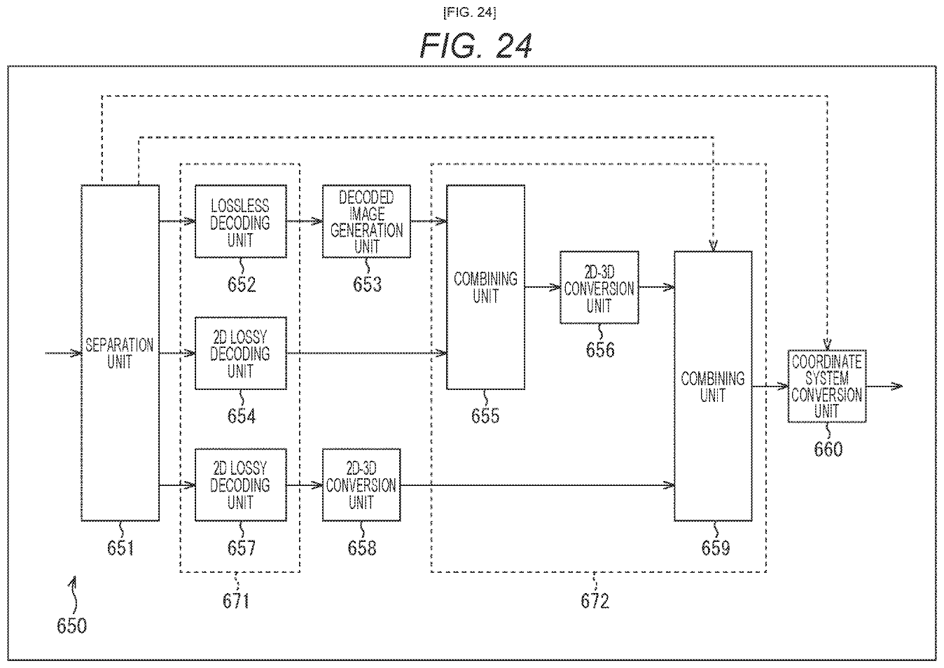

FIG. 24 is a block diagram of this case, the block diagram illustrating an example of a configuration of a decoding apparatus that is an embodiment of an image processing apparatus to which the present technology is applied. A decoding apparatus 650 illustrated in FIG. 24 is an apparatus that decodes the coded data of the 3D data generated by the above-described encoding apparatus 600 and detected in the real space. For example, the decoding apparatus 650 can decode the coded data of the 3D data by applying the present technology described in the present embodiment.

Note that, in FIG. 24, main parts of processing units, data flows, and the like are illustrated, and those illustrated in FIG. 24 are not necessarily all. That is, in the decoding apparatus 650, there may be a processing unit not illustrated as a block in FIG. 24, or there may be a flow of processing or data not illustrated as an arrow or the like in FIG. 24.

As illustrated in FIG. 24, the decoding apparatus 650 includes a separation unit 651, a lossless decoding unit 652, a decoded image generation unit 653, a 2D lossy decoding unit 654, a combining unit 655, a 2D-3D conversion unit 656, a 2D lossy decoding unit 657, a 2D-3D conversion unit 658, a combining unit 659, and a coordinate system conversion unit 660. The lossless decoding unit 652, the 2D lossy decoding unit 654, and the 2D lossy decoding unit 657 may be regarded as a decoding unit 671 in the present disclosure. Furthermore, the combining unit 655, the 2D-3D conversion unit 656, and the combining unit 659 may be regarded as a combining unit 672 in the present disclosure.

The separation unit 651 acquires the coded data (bitstream) of the 3D data input to the decoding apparatus 650. The separation unit 651 parses the acquired bitstream and separates the bitstream into the coded data of the function model, the coded data of the residual image, the coded data of the background signal data, and the meta information. In other words, the separation unit 651 extracts these pieces of information from the bitstream. The separation unit 651 supplies the coded data of the extracted function model to the lossless decoding unit 652. Furthermore, the separation unit 651 supplies the coded data of the extracted residual image to the 2D lossy decoding unit 654. Moreover, the separation unit 651 supplies the coded data of the extracted background signal data to the 2D lossy decoding unit 657. Furthermore, in a case where the extracted meta information includes information regarding coordinate system conversion, the separation unit 651 may supply the coordinate system conversion unit 660 with the information regarding the coordinate system conversion. Moreover, in a case where the extracted meta information includes information regarding data sorting (for example, a threshold value or the like), the separation unit 651 may supply the combining unit 659 with the information regarding the data sorting.

The lossless decoding unit 652 acquires the coded data of the function model supplied from the separation unit 651. The lossless decoding unit 652 decodes the coded data of the acquired function model with a lossless decoding method to generate (restore) a function model (that is, information indicating a function that constitutes the function model, a parameter of the function, and the like). This decoding method of the decoding may be any decoding method as long as the decoding method is a decoding method (a lossless decoding method) corresponding to an encoding method applied to encoding of a function model. For example, as described above in <2. Sorting based on signal intensity>, the decoding method may be a decoding method corresponding to an encoding method specified by the information regarding encoding included in the meta information. The lossless decoding unit 652 supplies the function model to the decoded image generation unit 653.

The decoded image generation unit 653 acquires the function model supplied from the lossless decoding unit 652. By using the acquired function model, the decoded image generation unit 653 generates 2D data (decoded image) equivalent to the function model. The decoded image generation unit 653 plots the function model to generate a decoded image, similarly to a case of the decoded image generation unit 405 described above. That is, there is generated a decoded image corresponding to each of 2D data obtained by performing 3D-2D conversion on the 3D data having a three-dimensional structure and detected in the real space (an image obtained by plotting, on a plane of each of the 2D data, a function model corresponding to the plane). The decoded image generation unit 653 supplies the generated decoded image to the combining unit 655.

The 2D lossy decoding unit 654 acquires the coded data of the residual image supplied from the separation unit 651. The 2D lossy decoding unit 654 performs, with a lossy decoding method, 2D decoding on the acquired coded data of the residual image to generate (restore) a residual image. This decoding method of the 2D decoding may be any decoding method as long as the decoding method is a decoding method (a lossy decoding method, and a 2D decoding method) corresponding to an encoding method applied to encoding of a residual image. For example, as described above in <2. Sorting based on signal intensity>, the decoding method may be a decoding method corresponding to an encoding method specified by the information regarding encoding included in the meta information. The 2D lossy decoding unit 654 supplies the residual image to the combining unit 655.

The combining unit 655 acquires the decoded image supplied from the decoded image generation unit 653. Furthermore, the combining unit 655 acquires the residual image supplied from the 2D lossy decoding unit 654. The combining unit 655 combines the acquired decoded image and residual image to generate (restore) main signal data of 2D data. The combining unit 655 supplies the generated main signal data of 2D data to the 2D-3D conversion unit 656.

The 2D-3D conversion unit 656 acquires the main signal data supplied from the combining unit 655. The main signal data is 2D data having a two-dimensional structure. The 2D-3D conversion unit 656 performs 2D-3D conversion on the acquired main signal data of 2D data. The main signal data subjected to the 2D-3D conversion is 3D data having a three-dimensional structure. The 2D-3D conversion unit 656 supplies the main signal data of 3D data to the combining unit 659. A method for the 2D-3D conversion is arbitrary. For example, inverse conversion of the 3D-2D conversion as described with reference to FIG. 2 may be used.

The 2D lossy decoding unit 657 acquires the coded data of the background signal data supplied from the separation unit 651. The 2D lossy decoding unit 657 performs, with a lossy decoding method, 2D decoding on the coded data of the acquired background signal data to generate (restore) the background signal data of 2D data. This decoding method of the 2D decoding may be any decoding method as long as the decoding method is a decoding method (a lossy decoding method, and a 2D decoding method) corresponding to an encoding method applied to encoding of background signal data. For example, as described above in <2. Sorting based on signal intensity>, the decoding method may be a decoding method corresponding to an encoding method specified by the information regarding encoding included in the meta information. The 2D lossy decoding unit 657 supplies the background signal data to the 2D-3D conversion unit 658.

The 2D-3D conversion unit 658 acquires the background signal data supplied from the 2D lossy decoding unit 657. The background signal data is 2D data having a two-dimensional structure. The 2D-3D conversion unit 658 performs 2D-3D conversion on the acquired background signal data of 2D data. The background signal data subjected to the 2D-3D conversion is 3D data having a three-dimensional structure. The 2D-3D conversion unit 658 supplies the background signal data of 3D data to the combining unit 659. A method for the 2D-3D conversion is arbitrary. For example, inverse conversion of the 3D-2D conversion as described with reference to FIG. 2 may be used.

The combining unit 659 acquires the main signal data supplied from the 2D-3D conversion unit 656. Furthermore, the combining unit 659 acquires the background signal data supplied from the 2D-3D conversion unit 658. Moreover, in a case where information regarding data sorting is supplied from the separation unit 651, the combining unit 659 may acquire the information regarding the data sorting. The combining unit 659 combines the acquired main signal data and background signal data to generate (restore) the 3D data in the orthogonal coordinate system. The method for combining the main signal data and the background signal data is arbitrary. For example, the combining unit 659 may combine the main signal data and the background signal data by using a predetermined threshold value for the 3D data having a three-dimensional structure and detected in the real space. Furthermore, the combining unit 659 may combine the main signal data and the background signal data on the basis of the information regarding data sorting (for example, a threshold value or the like) supplied from the separation unit 651. The combining unit 659 supplies the generated 3D data to the coordinate system conversion unit 660.

The coordinate system conversion unit 660 acquires the 3D data in the orthogonal coordinate system supplied from the combining unit 659. Furthermore, in a case where the information regarding the coordinate system conversion is supplied from the separation unit 651, the coordinate system conversion unit 660 may acquire the information regarding the coordinate system conversion.

The coordinate system conversion unit 660 converts the coordinate system of the acquired 3D data from the orthogonal coordinate system to the polar coordinate system. That is, the coordinate system conversion unit 660 generates (restores) the 3D data in the polar coordinate system (3D data having a three-dimensional structure and detected in the real space by, for example, the LiDAR sensor of the dToF method, or the like). A method for the coordinate system conversion is arbitrary. For example, the coordinate system of the 3D data may be converted from the orthogonal coordinate system to the polar coordinate system on the basis of the information from the separation unit 651 regarding the coordinate system conversion. The coordinate system conversion unit 660 outputs the generated 3D data in the polar coordinate system to outside of the decoding apparatus 650.

That is, the decoding unit 671 decodes the coded data of each of the function model and residual data of the main signal data and the background signal data that are obtained by sorting, on the basis of the signal intensity, the 3D data having a three-dimensional structure and detected in the real space, to generate a function model and residual data of the main signal data and the background signal data. The combining unit 672 combines the 2D data (decoded image) equivalent to the function model, the residual data (residual image), and the background signal data to generate (restore) the 3D data having a three-dimensional structure and detected in the real space.

For example, the decoding unit 671 decodes each of the coded data of the function model of the main signal data, the coded data of the residual data of the main signal data, and the coded data of the background signal data that are supplied from the separation unit 651, to generate a function model (such as a parameter indicating the function model) and residual data (residual image) of the main signal data, and background signal data. The decoding unit 671 supplies the function model of the main signal data to the decoded image generation unit 653, supplies the residual data of the main signal data to the combining unit 672, and supplies the background signal data to the 2D-3D conversion unit 658.

The combining unit 672 combines the decoded image (2D data equivalent to the function model of the main signal data) supplied from the decoded image generation unit 653 with the residual image (residual data of the main signal data) supplied from the decoding unit 671, to generate main signal data of 2D data. Then, the combining unit 672 performs 2D-3D conversion on the main signal data to generate main signal data of 3D data. Moreover, the combining unit 672 combines the main signal data with the background signal data of 3D data supplied from the 2D-3D conversion unit 658, to generate (restore) the 3D data having a three-dimensional structure and detected in the real space. The combining unit 672 supplies the 3D data to the coordinate system conversion unit 660.

With the above configuration, the decoding apparatus 650 can scalably decode the coded data of 3D data having a three-dimensional structure and detected in the real space.

### <Flow of Decoding Processing>

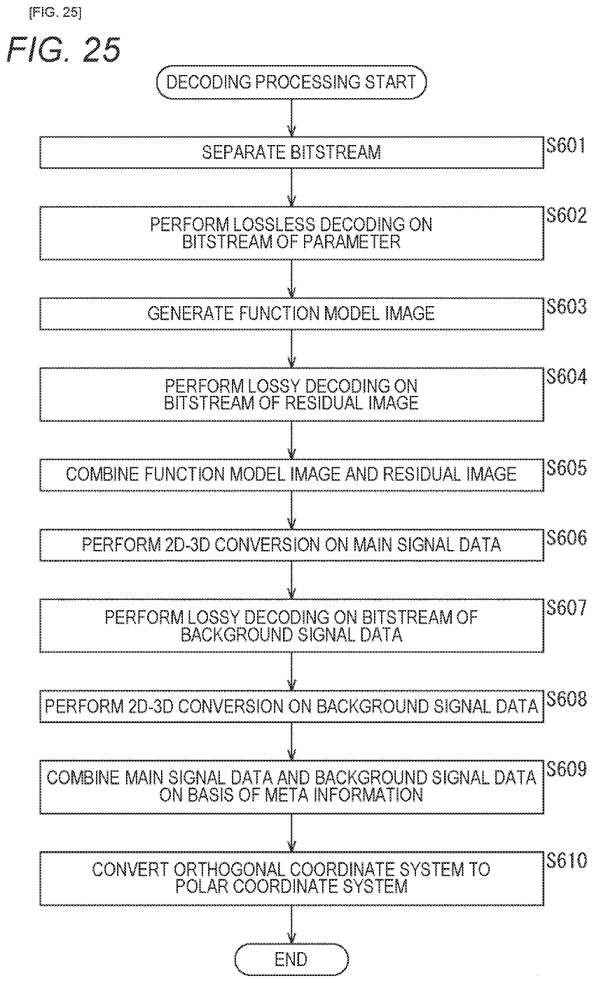

An example of a flow of decoding processing executed by the decoding apparatus 650 will be described with reference to the flowchart in FIG. 25.

When the decoding processing is started, in Step S601, the separation unit 651 of the decoding apparatus 650 separates the bitstream into the coded data of the function model, the coded data of the residual image, the coded data of the background signal data, and the meta information.

In Step S602, the lossless decoding unit 652 decodes, with a lossless decoding method, the coded data (bitstream) of the function model obtained in the processing in Step S601 to generate (restore) the function model (that is, information indicating a function that constitutes a function model, a parameter of the function, and the like).

In Step S603, the decoded image generation unit 653 generates 2D data (decoded image) equivalent to the function model generated in the processing in Step S602.

In Step S604, the 2D lossy decoding unit 654 performs, with a lossy decoding method, 2D decoding on the coded data of the residual image obtained in the processing in Step S601, to generate (restore) the residual image.

In Step S605, the combining unit 655 combines the decoded image generated in the processing in Step S603 and the residual image generated in the processing in Step S604 to generate (restore) the main signal data of 2D data.

In Step S606, the 2D-3D conversion unit 656 performs 2D-3D conversion on the main signal data of 2D data generated in Step S605 to generate (restore) the main signal data of 3D data.

In Step S607, the 2D lossy decoding unit 657 performs, with a lossy decoding method, 2D decoding on the coded data of the background signal data obtained in the processing in Step S601 to generate (restore) the background signal data of 2D data.

In Step S608, the 2D-3D conversion unit 658 performs 2D-3D conversion on the background signal data of 2D data generated in the processing in Step S607 to generate (restore) the background signal data of 3D data. In Step S609, the combining unit 659 combines, on the basis of the meta information obtained in the processing in Step S601, the main signal data generated in the processing in Step S606 and the background signal data generated in the processing in Step S608 to generate (restore) the 3D data in the orthogonal coordinate system. For example, the combining unit 659 combines the main signal data and the background signal data on the basis of the information regarding data sorting included in the meta information.

In Step S610, on the basis of the meta information obtained in the processing in Step S601, the coordinate system conversion unit 660 converts the coordinate system of the 3D data generated in the processing in Step S609 from the orthogonal coordinate system to the polar coordinate system. For example, the coordinate system conversion unit 660 converts the coordinate system of the 3D data on the basis of the information regarding the coordinate system conversion included in the meta information.

When the processing in Step S610 ends, the decoding processing ends.

By executing each processing as described above, the decoding apparatus 650 can scalably decode the coded data of 3D data having a three-dimensional structure and detected in the real space.

### 6. Supplementary Note

### <3D Data>

The present technology can be applied to encoding and decoding of 3D data of an arbitrary standard. That is, in so far as there is no conflict with the above-described present technology, various types of processing such as an encoding/decoding method, and specifications of various types of data such as 3D data and metadata are arbitrary. Furthermore, in so far as there is no conflict with the present technology, part of the above-described processing or specifications may be omitted.

### <Computer>

The above-described series of processing can be executed by hardware or software. In a case where the series of processing is executed by software, a program that constitutes the software is installed in a computer. Here, the computer includes a computer incorporated in dedicated hardware, a general-purpose personal computer capable of executing various functions by installing various programs, and the like, for example.

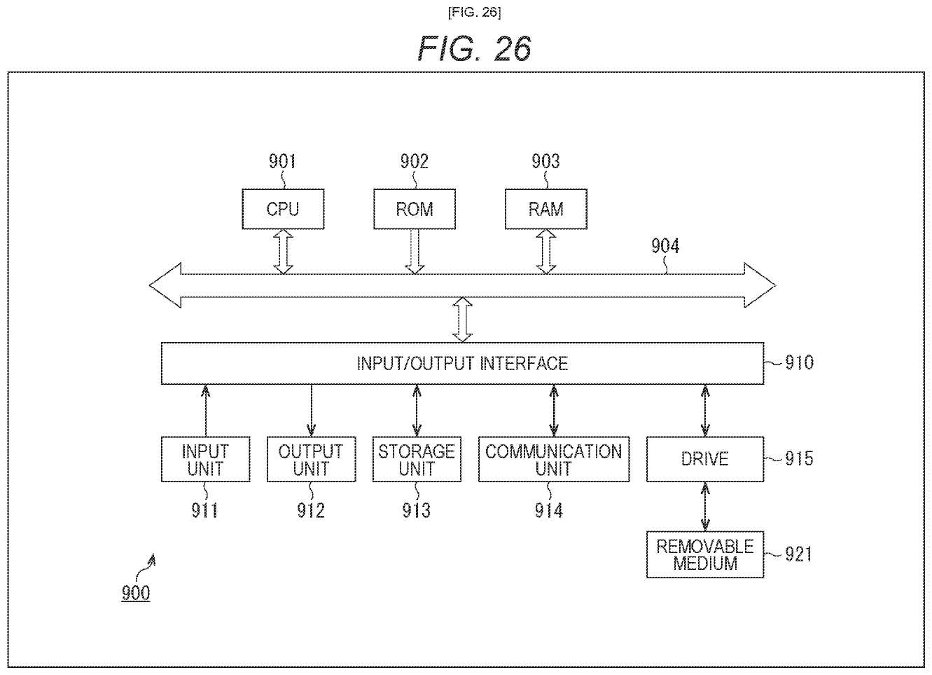

FIG. 26 is a block diagram illustrating a configuration example of hardware of a computer that executes the above-described series of processing by a program.

In a computer 900 illustrated in FIG. 26, a central processing unit (CPU) 901, a read only memory (ROM) 902, and a random access memory (RAM) 903 are mutually connected via a bus 904.

An input/output interface 910 is also connected to the bus 904. An input unit 911, an output unit 912, a storage unit 913, a communication unit 914, and a drive 915 are connected to the input/output interface 910.

The input unit 911 includes, for example, a keyboard, a mouse, a microphone, a touch panel, an input terminal, and the like. The output unit 912 includes, for example, a display, a speaker, an output terminal, and the like. The storage unit 913 includes, for example, a hard disk, a RAM disk, a nonvolatile memory, and the like. The communication unit 914 includes a network interface, for example. The drive 915 drives a removable medium 921 such as a magnetic disk, an optical disk, a magneto-optical disk, or a semiconductor memory.

In the computer configured as described above, for example, the CPU 901 loads a program stored in the storage unit 913 into the RAM 903 via the input/output interface 910 and the bus 904 and executes the program, whereby the above-described series of processing is performed. Furthermore, the RAM 903 also appropriately stores data necessary for the CPU 901 to execute various processing.

The program executed by the computer can be applied by being recorded on, for example, the removable medium 921 as a package medium or the like. In this case, the program can be installed in the storage unit 913 via the input/output interface 910 by attaching the removable medium 921 to the drive 915.

Furthermore, the program can also be provided via a wired or wireless transmission medium such as a local area network, the Internet, or digital satellite broadcasting. In this case, the program can be received by the communication unit 914 and installed on the storage unit 913.

In addition, this program can be installed in the ROM 902 or the storage unit 913 in advance.

### <Applicable Target of Present Technology>

The present technology can be applied to any configuration. For example, the present technology may be applied to various electronic devices.

Furthermore, for example, the present technology can also be implemented as a partial configuration of an apparatus, such as a processor (for example, a video processor) as a system large scale integration (LSI) or the like, a module (for example, a video module) using a plurality of processors or the like, a unit (for example, a video unit) using a plurality of modules or the like, or a set (for example, a video set) obtained by further adding other functions to a unit.

Furthermore, for example, the present technology can also be applied to a network system including a plurality of apparatuses. For example, the present technology may be implemented as cloud computing shared and processed in cooperation by a plurality of apparatuses via a network. For example, the present technology may be implemented in a cloud service that provides a service related to an image (moving image) to any terminal such as a computer, an audio visual (AV) device, a portable information processing terminal, or an Internet of Things (IoT) device.

Note that, in the present specification, a system means a set of a plurality of components (apparatuses, modules (parts), and the like), and it does not matter whether or not all the components are in the same housing. Therefore, both of a plurality of apparatuses stored in different housings and connected via a network, and one apparatus in which a plurality of modules is stored in one housing are systems.

<Field/Application to which Present Technology is Applicable>

The system, apparatus, processing unit and the like to which the present technology is applied can be used in arbitrary fields such as traffic, medical care, crime prevention, agriculture, livestock industry, mining, beauty care, factory, household appliance, weather, and natural surveillance, for example. Furthermore, any application thereof may be used.

### <Others>

Note that, in the present specification, various kinds of information (such as metadata) related to coded data (a bitstream) may be transmitted or recorded in any form as long as it is associated with the coded data. Here, the term “associating” means, when processing one data, allowing other data to be used (to be linked), for example. That is, the data associated with each other may be collected as one data or may be made individual data. For example, information associated with the coded data (image) may be transmitted on a transmission path different from that of the coded data (image). Furthermore, for example, the information associated with the coded data (image) may be recorded in a recording medium different from that of the coded data (image) (or another recording area of the same recording medium). Note that, this “association” may be not the entire data but a part of data. For example, an image and information corresponding to the image may be associated with each other in any unit such as a plurality of frames, one frame, or a part within a frame.

Note that, in the present specification, terms such as “combine”, “multiplex”, “add”, “integrate”, “include”, “store”, “put in”, “introduce”, “insert”, and the like mean, for example, to combine a plurality of objects into one, such as to combine coded data and metadata into one data, and mean one method of “associating” described above.

Furthermore, the embodiments of the present technology are not limited to the above-described embodiments, and various modifications are possible without departing from the scope of the present technology.

For example, a configuration described as one apparatus (or processing unit) may be divided and configured as a plurality of apparatuses (or processing units). Conversely, configurations described above as a plurality of apparatuses (or processing units) may be collectively configured as one apparatus (or processing unit). Furthermore, a configuration other than the above-described configurations may be added to the configuration of each apparatus (or each processing unit). Moreover, if the configuration and operation of the entire system are substantially the same, a part of the configuration of a certain apparatus (or processing unit) may be included in the configuration of another apparatus (or another processing unit).

Furthermore, for example, the above-described programs may be executed in an arbitrary apparatus. In this case, the apparatus is only required to have a necessary function (functional block, or the like) and obtain necessary information.

Furthermore, for example, each step in one flowchart may be executed by one apparatus, or may be executed by being shared by a plurality of apparatuses. Moreover, in a case where a plurality of pieces of processing is included in one step, the plurality of pieces of processing may be executed by one apparatus, or may be shared and executed by a plurality of apparatuses. In other words, a plurality of pieces of processing included in one step can also be executed as processing of a plurality of steps. Conversely, the processing described as a plurality of steps can be collectively executed as one step.

Furthermore, for example, in a program executed by the computer, processing of steps describing the program may be executed in a time-series order in the order described in the present specification, or may be executed in parallel or individually at a required timing such as when a call is made. That is, as long as there is no contradiction, the processing of each step may be executed in an order different from the above-described order. Moreover, this processing of steps describing program may be executed in parallel with processing of another program, or may be executed in combination with processing of another program.

Furthermore, for example, a plurality of techniques related to the present technology can be implemented independently as a single body as long as there is no contradiction. A plurality of arbitrary present technologies can be implemented in combination. For example, part or all of the present technologies described in any of the embodiments can be implemented in combination with part or all of the present technologies described in other embodiments. Furthermore, a part or all of the present technologies described above may be implemented in combination with another technology not described above.

Note that the present technology may also have the following configurations.

(1) An image processing apparatus including
a sorting unit that sorts, on the basis of a signal intensity, a 3D data having a three-dimensional structure and detected in a real space, into a main signal data and a background signal data, and
an encoding unit that encodes each of the main signal data and the background signal data that are sorted out by the sorting unit, to generate coded data.

(2) The image processing apparatus according to (1),
in which the encoding unit encodes the main signal data with a lossless encoding method, and encodes the background signal data with a lossy encoding method.

(3) The image processing apparatus according to (2), the image processing apparatus further including a conversion unit that converts each of the main signal data and the background signal data to 2D data having a two-dimensional structure,
in which the encoding unit encodes each of the main signal data of the 2D data and the background signal data of the 2D data.

(4) The image processing apparatus according to (2) or (3), the image processing apparatus further including a meta information addition unit that adds, to the coded data, meta information including an encoding method applied to encoding of the main signal data and an encoding method applied to encoding of the background signal data.

(5) The image processing apparatus according to any one of (2) to (4),
in which the data sorting unit sorts the 3D data into data having the signal intensity greater than a predetermined threshold value as the main signal data, and sorts the 3D data into data having the signal intensity equal to or smaller than the predetermined threshold value as the background signal data.

(6) The image processing apparatus according to (5), the image processing apparatus further including a meta information addition unit that adds meta information including information indicating the threshold value to the coded data.

(7) The image processing apparatus according to any one of (2) to (4),
in which the sorting unit sorts out a function model of the 3D data as the main signal data and sorts out a difference value between the 3D data and the function model as the background signal data.

(8) The image processing apparatus according to any one of (2) to (4),
in which the sorting unit
sorts out the 3D data having the signal intensity greater than a predetermined threshold value as the main signal data, and
sorts out the 3D data having the signal intensity equal to or smaller than the threshold value as the background signal data, and
moreover, sorts the main signal data into a function model of the main signal data and a difference value between the main signal data and the function model.

(9) The image processing apparatus according to any one of (1) to (8),
in which the 3D data is a reflection intensity distribution detected in the real space.

(10) An image processing method including
sorting 3D data having a three-dimensional structure and detected in a real space into main signal data and background signal data on the basis of signal intensity, and
encoding each of the sorted main signal data and the background signal data to generate coded data.

(11) An image processing apparatus including
a decoding unit that decodes coded data of each of main signal data and background signal data that are obtained by sorting, on the basis of signal intensity, 3D data having a three-dimensional structure and detected in a real space, to generate the main signal data and the background signal data, and
a combining unit that combines the main signal data and the background signal data that are generated by the decoding unit, to generate the 3D data.

(12) The image processing apparatus according to (11),
in which the decoding unit decodes the coded data of the main signal data with a lossless decoding method, and decodes the coded data of the background signal data with a lossy decoding method.

(13) The image processing apparatus according to (12),
in which the decoding unit decodes the coded data of each of the main signal data having a two-dimensional structure and the background signal data having a two-dimensional structure.

(14) The image processing apparatus according to (12) or (13),
in which the decoding unit decodes the coded data of each of the main signal data and the background signal data by using a decoding method corresponding to an encoding method for each of the main signal data and the background signal data that are included in meta information added to the coded data.

(15) The image processing apparatus according to any one of (12) to (14),
in which the combining unit combines the main signal data and the background signal data by using a predetermined threshold value for the 3D data.

(16) The image processing apparatus according to (15),
in which the combining unit combines the main signal data and the background signal data by using a threshold value included in meta information added to the coded data.

(17) The image processing apparatus according to any one of (12) to (14),
in which the decoding unit
decodes the coded data of the main signal data to generate a function model of the 3D data, and
decodes the coded data of the background signal data to generate a difference value between the 3D data and the function model, and
the combining unit combines an image corresponding to the function model and the difference value to generate the 3D data.

(18) The image processing apparatus according to any one of (12) to (14),
in which the decoding unit decodes each of the coded data of the function model of the main signal data, the coded data of a difference value between the main signal data and the function model, and the coded data of the background signal data, and
the combining unit
combines an image of the function model and the difference value to generate the main signal data, and
combines the main signal data and the background signal data to generate the 3D data.

(19) The image processing apparatus according to any one of (11) to (18),
in which the 3D data is a reflection intensity distribution detected in the real space.

(20) An image processing method including
decoding coded data of each of main signal data and background signal data that are obtained by sorting, on the basis of signal intensity, 3D data having a three-dimensional structure and detected in a real space, to generate the main signal data and the background signal data, and
combining generated the main signal data and the background signal data, to generate the 3D data.

### REFERENCE SIGNS LIST

200 Encoding apparatus
201 Coordinate system conversion unit
202 Data sorting unit
203 3D-2D conversion unit
204 2D lossless encoding unit
205 3D-2D conversion unit
206 2D lossy encoding unit
207 Combining unit
208 Meta information addition unit
250 Decoding apparatus
251 Separation unit
252 2D lossless decoding unit
253 2D-3D conversion unit
254 2D lossy decoding unit
255 2D-3D conversion unit
256 Combining unit
257 Coordinate system conversion unit
400 Encoding apparatus
401 Coordinate system conversion unit
402 3D-2D conversion unit
403 Function model generation unit
404 Lossless encoding unit
405 Decoded image generation unit
406 Residual derivation unit
407 2D lossy encoding unit
408 Combining unit
409 Meta information addition unit
450 Decoding apparatus
451 Separation unit
452 Lossless decoding unit
453 Decoded image generation unit
454 2D lossy decoding unit
455 Combining unit
456 2D-3D conversion unit
457 Coordinate system conversion unit
600 Encoding apparatus
601 Coordinate system conversion unit
602 Data sorting unit
603 3D-2D conversion unit
604 Function model generation unit
605 Lossless encoding unit
606 Decoded image generation unit
607 Residual derivation unit
608 2D lossy encoding unit
609 3D-2D conversion unit
610 2D lossy encoding unit
611 Combining unit
612 Meta information addition unit
60 Decoding apparatus
651 Separation unit
652 Lossless decoding unit
653 Decoded image generation unit
654 2D lossy decoding unit
655 Combining unit
656 2D-3D conversion unit
657 2D lossy decoding unit
658 2D-3D conversion unit
659 Combining unit
660 Coordinate system conversion unit
900 Computer

1. An image processing apparatus comprising:
a sorting unit that sorts, on a basis of a signal intensity, a 3D data having a three-dimensional structure and detected in a real space, into a main signal data and a background signal data; and
an encoding unit that encodes each of the main signal data and the background signal data that are sorted out by the sorting unit, to generate coded data.

2. The image processing apparatus according to claim 1,
wherein the encoding unit encodes the main signal data with a lossless encoding method, and encodes the background signal data with a lossy encoding method.

3. The image processing apparatus according to claim 2, the image processing apparatus further comprising a conversion unit that converts each of the main signal data and the background signal data to 2D data having a two-dimensional structure,
wherein the encoding unit encodes each of the main signal data of the 2D data and the background signal data of the 2D data.

4. The image processing apparatus according to claim 2, the image processing apparatus further comprising a meta information addition unit that adds, to the coded data, meta information including an encoding method applied to encoding of the main signal data and an encoding method applied to encoding of the background signal data.

5. The image processing apparatus according to claim 2,
wherein the data sorting unit sorts the 3D data into data having the signal intensity greater than a predetermined threshold value as the main signal data, and sorts the 3D data into data having the signal intensity equal to or smaller than the predetermined threshold value as the background signal data.

6. The image processing apparatus according to claim 5, the image processing apparatus further comprising a meta information addition unit that adds meta information including information indicating the threshold value to the coded data.

7. The image processing apparatus according to claim 2,
wherein the sorting unit sorts out a function model of the 3D data as the main signal data and sorts out a difference value between the 3D data and the function model as the background signal data.

8. The image processing apparatus according to claim 2,
wherein the sorting unit
sorts out the 3D data having the signal intensity greater than a predetermined threshold value as the main signal data, and
sorts out the 3D data having the signal intensity equal to or smaller than the threshold value as the background signal data, and
moreover, sorts the main signal data into a function model of the main signal data and a difference value between the main signal data and the function model.

9. The image processing apparatus according to claim 1,
wherein the 3D data is a reflection intensity distribution detected in the real space.

10. An image processing method comprising:
sorting 3D data having a three-dimensional structure and detected in a real space into main signal data and background signal data on a basis of signal intensity; and
encoding each of the sorted main signal data and the background signal data to generate coded data.

11. An image processing apparatus comprising:
a decoding unit that decodes coded data of each of main signal data and background signal data that are obtained by sorting, on a basis of signal intensity, 3D data having a three-dimensional structure and detected in a real space, to generate the main signal data and the background signal data; and
a combining unit that combines the main signal data and the background signal data that are generated by the decoding unit, to generate the 3D data.

12. The image processing apparatus according to claim 11,
wherein the decoding unit decodes the coded data of the main signal data with a lossless decoding method, and decodes the coded data of the background signal data with a lossy decoding method.

13. The image processing apparatus according to claim 12,
wherein the decoding unit decodes the coded data of each of the main signal data having a two-dimensional structure and the background signal data having a two-dimensional structure.

14. The image processing apparatus according to claim 12,
wherein the decoding unit decodes the coded data of each of the main signal data and the background signal data by using a decoding method corresponding to an encoding method for each of the main signal data and the background signal data that are included in meta information added to the coded data.

15. The image processing apparatus according to claim 12,
wherein the combining unit combines the main signal data and the background signal data by using a predetermined threshold value for the 3D data.

16. The image processing apparatus according to claim 15,
wherein the combining unit combines the main signal data and the background signal data by using a threshold value included in meta information added to the coded data.

17. The image processing apparatus according to claim 12,
wherein the decoding unit
decodes the coded data of the main signal data to generate a function model of the 3D data, and
decodes the coded data of the background signal data to generate a difference value between the 3D data and the function model, and
the combining unit combines an image corresponding to the function model and the difference value to generate the 3D data.

18. The image processing apparatus according to claim 12,
wherein the decoding unit decodes each of the coded data of the function model of the main signal data, the coded data of a difference value between the main signal data and the function model, and the coded data of the background signal data, and
the combining unit
combines an image of the function model and the difference value to generate the main signal data, and
combines the main signal data and the background signal data to generate the 3D data.

19. The image processing apparatus according to claim 11,
wherein the 3D data is a reflection intensity distribution detected in the real space.

20. An image processing method comprising:
decoding coded data of each of main signal data and background signal data that are obtained by sorting, on a basis of signal intensity, 3D data having a three-dimensional structure and detected in a real space, to generate the main signal data and the background signal 10 data; and
combining generated the main signal data and the background signal data, to generate the 3D data.
